(19) United States
(12) Patent Application Publication
(10) Pub. No.: US 2002/0123954 A1
(43) Pub. Date: Sep. 5, 2002

(54) Investing method, device for investing and investing system

(76) Inventor: Kenji Hito, Chiba-shi (JP)

Correspondence Address: Mark Montague, Esq., Cowan, Liebowitz & Latman, P.C., 1133 Avenue of the Americas, New York, NY, 10036, US

(21) Appl. No.: 10/047,531

(22) Filed: Oct. 23, 2001

(30) Foreign Application Priority Data
Nov. 2, 2000 (JP) 2000-336775

(51) Int. Cl. G06F 17/60

(52) U.S. Cl. 705/36; 705/35

(57) ABSTRACT

An investing method, a device for investing, and a system for investing which do not expose a client's invested capital to risks such as loss of principal value, for example, and yet which are capable of producing large profits and are attractive to both the client and a financial institution. Disclosed is an investing method in which a part or all of interest applied by the financial institution to the investment principal invested by the client is used as funds for investing and is appropriated for purchases of options based on predictions by the client regarding predetermined phenomena on each of the predetermined dates, and these option purchases are repeated during a given period having been determined in advance.

### BACKGROUND OF THE INVENTION

1. Field of the Invention

The present invention relates to an investing method, a device for investing and a investing system for performing purchase of an option product using interest generated from a client's investment principle, for example, as funds for investing.

2. Description of the Related Art

There are many kinds of financial products, including very stable products with little risk of loss of principal value, for example, and products with high returns but with high risk. Products with little risk of loss of principal value include Yen deposits and foreign currency deposits, for example. Also, high-return financial products include, for example, investment trusts, deposit products involving sales and purchases of varieties of options, and derivatives (i.e., financial derivative products) such as option transactions, swap transactions and futures transactions.

In the case of foreign currency deposits, for example, there are situations in which profit or loss emerges due to exchange fluctuations when the deposited foreign currency is converted into Yen, for example. However, if the exchange fluctuations are minor, then there is little influence incurred. In other words, there is little possibility of producing a large profit, but on the other hand, there is also little possibility of producing a large loss.

On the other hand, in the case of high return financial products there is a possibility of incurring great loss of principal value (i.e., incurring great loss), but there is also a great possibility of producing a large profit. Note that high return products offered by financial institutions include more of an element of gambling than deposits do; however, the risk involved here is typically hedged.

For example, an investment trust fund is a financial product in which a financial institution having been entrusted with a client's funds for investing (i.e., a fund manager) draws capital from many clients and manages this money for the clients. These funds are typically managed by a method in which a part of the capital is used to purchase a highly profitable investment object, and the remaining capital is used to purchase a highly stable investment object. In other words, an investment trust fund can be said to be a financial product in which the fund manager, who is a financial professional having been entrusted with the management of clients' money, hedges a given risk while achieving a balance between profitability and stability. Note that in the case of other high return products such as stocks and options as well, the method of hedging risk is adopted in which a part of the funds for investing is used for highly profitable capital management and the remainder is used for highly stable capital management.

As described above, in the case of the high return financial products, there is little risk of loss in connection with the portion that is invested in the stable investment object having a low fluctuation rate. Further, there are also cases when the portion that is invested in the highly profitable investment object having a relatively high fluctuation rate yields large profits. Additionally, the management thereof is conducted by the fund manager or other such financial professional for the client.

However, even if the management of the funds is performed by a financial professional, it is impossible to predict changes in the market completely. Therefore, even though a given risk hedge is being performed, it cannot be denied that there is a risk of a great loss. Particularly, there is no small possibility that a wrong prediction is made regarding a highly profitable investment object with a high fluctuation rate, and the investment capital will thus incur significant loss (i.e., incur a great loss). When a situation such as this occurs, there can be cases in which the client is hedging a certain amount of the investment capital but a loss of principal value is incurred nevertheless with respect to the funds for investing as a whole.

Moreover, in the case when the high return financial product structured for purchase of currency options, there is a danger that a loss will occur when the principal currency which is the investment capital is converted into other currencies. Additionally, in the case when the high return financial product is structured for purchase of equities options, for example, there is a danger that a loss will occur when the principal currency which is the investment capital is converted into stocks, etc.

Additionally, in the case when the client is not satisfied with the high return financial product described above and the client expects a greater profit than available in the typical high return financial product in which risk hedge is being performed, then financial products such as normal options trading and stock trading are used in which normal hedging of risk is not performed. In cases such as this, there is an even greater possibility of the client's losses becoming great.

### SUMMARY OF THE INVENTION

The present invention was developed to solve the problems described above. Therefore, an objective of the present invention is to obtain an investing method, a device for investing and an investing system which are attractive to both a client and a financial institution and are capable of producing a large profit without exposing the client's investment capital to risks such as loss of principal value.

In order to achieve this objective, according to the present invention, interest from the funds for investing is used for the costs of purchasing the options, so it becomes possible to reach the day on which rights may be exercised at least without diminishment of the investment principal. In other words, from the perspective of the client, even if a loss occurs through the purchase of an option, the return of the investment principal is guaranteed. Meanwhile, the option purchase is repeated using the interest as the funds for investing during a predetermined period, so when the client's prediction or expectation is correct every time and when the period is a long period, large profits can be obtained.

Further, in another investing method according to the present invention, interest from the funds for investing is divided according to the number of instances of the option purchase and these divided funds are used for the costs of purchasing the options, so it is possible to reach the day on which the rights can be exercised at least without diminishment of the investment principal. Accordingly, from the perspective of the client, even if a loss occurs through the purchase of an option, the return of the investment principal is guaranteed. Meanwhile, the option purchase is repeated using the interest as the funds for investing during a predetermined period, so when the client's prediction is correct every time and when the period is a long period, large profits can be obtained. Furthermore, the funds for investing to be used for the costs of purchasing the options in the beginning are divided according to the number of instances of the options purchases, so there is no danger of the funds for investing which are used for the costs of the option purchase vanishing, and there always remains the possibility of the client producing profits during the contract period.

Further, in another investing method according to the present invention, the option purchase is repeated during a given period having been determined in advance for the purchase of the options, and also, the client can select at least two of the following to use as funds for investing for the option purchase:

(1) a part of or all of interest set by a financial institution on an investment principal being invested by the client;

(2) divided funds consisting of funds that have been divided from a part of or all of interest, according to a number of instances of option purchases;

(3) a combination of a part of the investment principal and either (1) or (2) above;

(4) a combination of a part of or all of profits obtained by exercising a right on an option, and either (1) or (2) above;

(5) a combination of a part of or all of profits obtained by exercising a right on an option, and (3) above;

(6) an appropriate combination of (1)-(5) above.

Accordingly, it is possible for the client to select a management type of the funds for investing which fits with the client's own needs. For example, a client who at least wants 100% of the investment principal to be returned on the day when the rights can be exercised even if a loss has occurred through the option purchase (i.e., a client who seeks a guarantee of the investment principal) can select funds for investing from among (1), (2) and (4) above in order to realize this. Furthermore, a client who wishes to guarantee the investment principal and also wants to be sure the option purchase is repeated until the end of the contract period can select (2) above. And in the case of a client who, in addition to the requirement of guaranteeing the investment principal, expects to obtain a large profit through the option purchase, the client can select (4) above. In these ways, each can be realized respectively.

Further, in the case of a client who anticipates profits greater than those of (1), (2) and (4) but who has resigned himself to the loss of a part of the investment principal should a loss occur through the option purchase, this client can select (3) above to realize this. Furthermore, a client who anticipates profits even greater than those of (3) can select (5) above to realize this. Further, if the client selects (6), it is possible to modify (1)-(5) as necessary during the contract period during which the investing method is used (i.e., includes cases when the client makes selections himself and cases when the client has the financial institution arrange the settings appropriately), or the client can incorporate conditions at the time of entering the contract as deemed necessary, such as using (1) from a certain period until a certain period and then changing to (4), for example.

Further, in a device for investing according to the present invention, the device for investing is capable of being connected to from a client terminal device via a high speed communications network, and additionally capable of inputting and outputting information relevant to transactions with the connected client, characterized in that it is possible to perform at least either a purchase request for or a cancellation of a contract for a financial derivative product which uses one of the above investing methods. Accordingly, the client's transaction information is inputted from a client terminal device, whereby a sales management device can acknowledge the purchase request, for example, for the financial derivative product. Therefore, the client can use the terminal device which is connected to the high speed network and make a purchase, for example, of a financial derivative product which using the investing method as described above without particularly visiting the financial institution in person.

Further, another invention comprises a client information database in which client information including an account number is stored; a product database in which the content of each type of product is stored; an investment information database in which investment information including an applied rate of return is stored; a sales management database in which each type of data for each product purchased by each client is stored; and a management server connected to the databases and capable of inputting and outputting personal information and transaction information relevant to the client, characterized in that in the case when personal information relevant to the client is inputted to the management server the client information database is referenced based on the inputted data and the client is certified; the product database and the investment information database are referenced regarding the certified client and products which the financial institution can provide to that client at the time when the information is inputted are disclosed; and by inputting the certified client's transaction conditions, a purchase request is performed in accordance with these inputted conditions for a financial derivative product which uses the investing method described above; and the content of this transaction is inputted to the sales management database and managed.

Accordingly, when the client's personal information is inputted into the management server, the management server certifies the client and also extracts each type of necessary data from each database and provides this to the client, and the client can perform purchase request for a financial derivative product based on this information. Further, this transaction information is stored in a sales management database and, for example, can be automatically retrieved at a necessary time (such as upon premature cancellation of a contract or upon maturation, for example). In other words, the purchase request by the client and the management by the financial institution become easy.

Further, in an investing system according to the present invention, an investing system for implementing one of the above investing methods comprises a device for investing which is capable of being connected to from a client's client terminal device via a high speed communications network and also is capable of inputting and outputting information relevant to transactions with the connected client, whereby the client can use the client terminal device to purchase a financial derivative product which uses the investing method. Accordingly, by implementing this system, the client can use the client terminal device which is connected to the high speed communications network and make a purchase, for example, of a financial derivative product using an investing method such as the one described above without particularly visiting the financial institution in person.

Further, another investing system according to the present invention is an investing system for implementing one of the investing methods described above, characterized in that personal information relevant to the client is inputted to the management database whereby the client information database is referenced based on the inputted data and the client is certified, and after the certification, the client's desired transaction conditions are inputted whereby a purchase request can be performed for a financial derivative product which uses the above investing method.

### BRIEF DESCRIPTION OF THE DRAWINGS

In the accompanying drawings:

FIG. 1 is a chart for explaining concepts of an investing method according to the present invention, and for explaining one example of a prediction by a client which forms the basis of a purchase of an option;

FIG. 2 is a chart for explaining concepts of an investing method according to the present invention, and depicts relationships among an investment principal, interest, and funds for investing for the purchase of an option;

FIG. 3 is a chart for explaining concepts of an investing method according to the present invention, and is a chart depicting fluctuations in the funds for investing and in profits during a given period in a case when the funds for investing are comprised of a combination of all of the interest and all of the profits;

FIGS. 4A to 4F are charts for explaining concepts of an investing method according to the present invention, and depicting fluctuations in the investment principal, the interest, the funds for investing and the profits on each of predetermined dates during the given period, in a case when the funds for investing are comprised of all of the interest (being monthly interest) and management is carried out incorporating the profits obtained from each of the options purchases into the investment principal;

FIG. 5 is a device outline diagram depicting a device for investing and periphery thereof, according to Embodiment 1 of the present invention;

FIG. 6 is a diagram depicting interior data of a client information database of the device for investing of FIG. 5;

FIG. 7 is a diagram depicting interior data of a product database of the device for investing of FIG. 5;

FIG. 8 is a diagram depicting interior data of an investment information database of the device for investing of FIG. 5;

FIG. 9 is a diagram depicting interior data of a predictions database of the device for investing of FIG. 5;

FIG. 10 is a diagram depicting a flow of operations in a case when the device for investing of FIG. 5 is used to operate the system for investing according to the present invention, and specifically in the case when the client performs with a financial institution a transaction such as a purchase or a cancellation of a contract for a financial derivative product;

FIG. 11 is a device outline diagram depicting a device for investing and periphery thereof, according to Embodiment 2 of the present invention;

FIG. 12 is a diagram depicting interior data of a new product information unit of the device for investing of FIG. 11;

FIG. 13 is a diagram depicting interior data of a new product information unit of the device for investing of FIG. 11;

FIG. 14 is a diagram depicting interior data of a new product information unit of the device for investing of FIG. 11;

FIG. 15 is a device outline diagram depicting a device for investing and periphery thereof, according to Embodiment 2 of the present invention;

FIG. 16 is a diagram depicting one example of a web page stored in a web page server of the device for investing of FIG. 15;

FIG. 17 is a diagram depicting one example of a transaction request web page;

FIG. 18 is a diagram depicting one example of a financial derivative product transaction request web page;

FIG. 19 is a diagram depicting one example of a product introduction web page;

FIG. 20 is a diagram depicting one example of a product content explanation web page;

FIG. 21 is a diagram depicting one example of a selection web page;

FIG. 22 is a diagram depicting one example of an investment content settings web page;

FIG. 23 is a diagram depicting one example of a client prediction input web page;

FIG. 24 is a diagram depicting one example of a final confirmation web page;

FIG. 25 is a diagram depicting one example of a web page of a product management status list for clients currently engaged in utilization;

FIG. 26 is a diagram depicting one example of a management status detailed data chart web page; and

FIG. 27 is a diagram depicting one example of a premature contact cancellation web page.

### DETAILED DESCRIPTION OF THE PREFERRED EMBODIMENTS

Explanation will be made below of embodiments of an investing method, a device for investing and an investing system of the present invention.

Note that before making the explanation of the investing method, the device for investing and the investing system, explanation will first be made of characteristics of financial derivative products which are managed by means of the investing method according to the present invention.

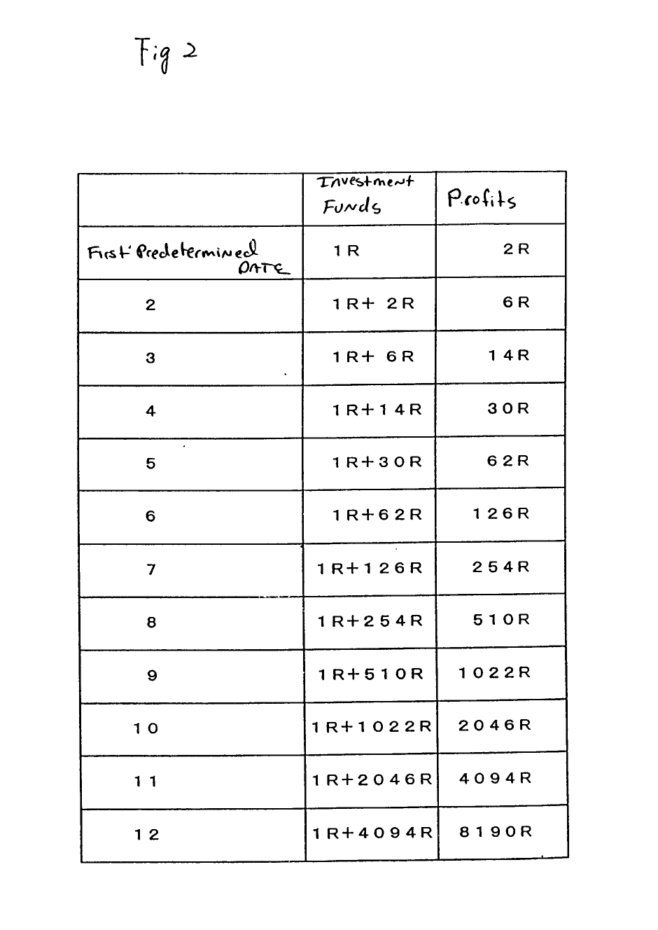

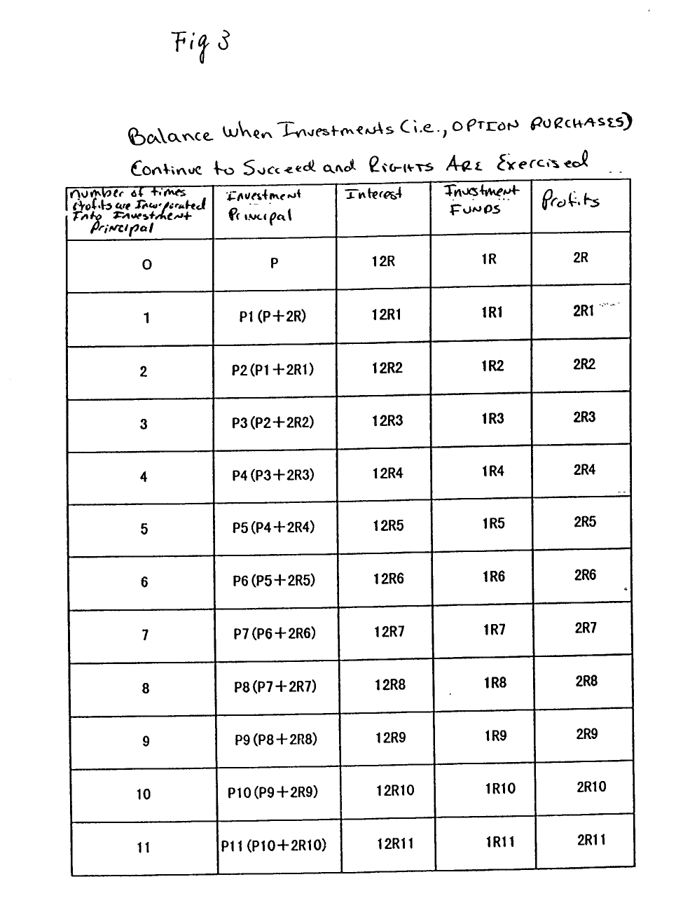

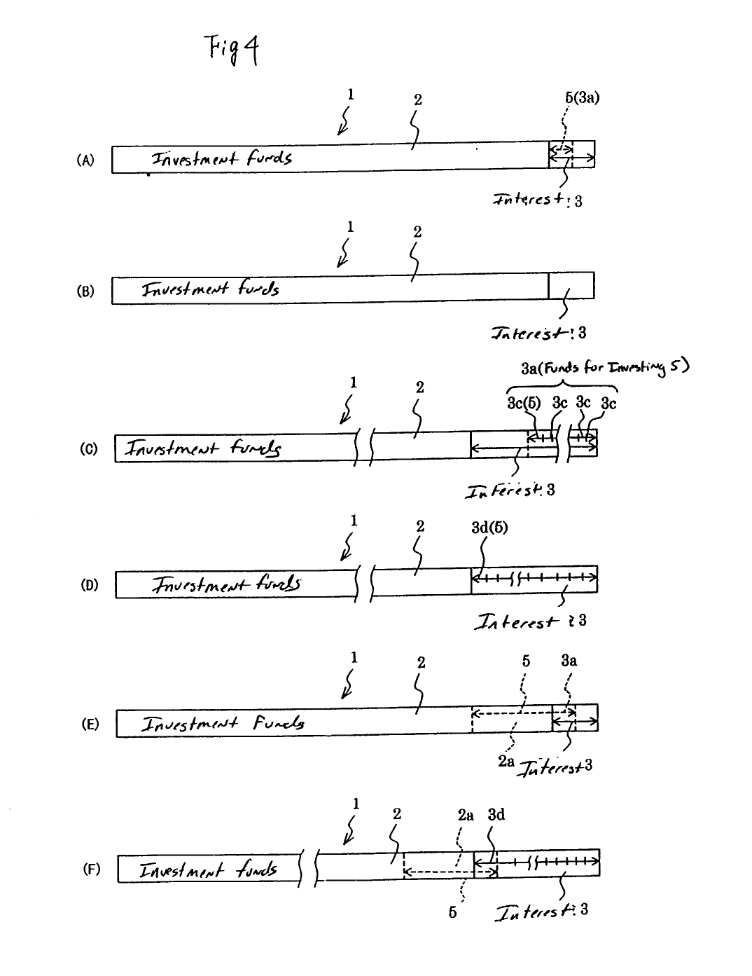

A first characteristic of the financial derivative products which are managed by means of the investing method according to the present invention is that during a predetermined period funds for investing and entrusted to a financial institution by a client are repeatedly appropriated for costs of purchasing options on predetermined dates. Note that funds for investing, as explained below, refer to funds which use interest from an investment principal, for example, and are applied to the costs of purchasing options. An explanation regarding the capital which is used as the funds for investing will be made below according to type using FIG. 2, FIG. 3 and FIGS. 4A to 4F.

With the financial derivative products managed by the investing method according to the present invention, the interest is used and repeatedly invested in this way. Accordingly, even when the original funds for investing was not very large, it ultimately leads to an extremely large profit if the client's predictions continue to be accurate.

A second characteristic of the financial derivative products which are managed by means of the investing method according to the present invention is that all of the investment principal or a portion thereof being determined by a selection made by the client is not appropriated for the option purchase costs. Therefore, this portion, which is not appropriated, is guaranteed to be paid back in the end. As a result, even if the client's prediction (or expectation) is off (i.e., incorrect) and the funds for investing used for the option purchase costs are lost, the sum of the lost funds for investing does not exceed the amount of a sum within a range selected by the client in advance.

A third characteristic of the financial derivative products which are managed by means of the investing method according to the present invention is that an option is purchased in which a predetermined phenomenon is predicted, such as a strong Yen (i.e., put) or a weak Yen (i.e., call) for a predetermined date, and in the event that this prediction is correct a right can be exercised. Accordingly, the will of the client is contributed to the purchase of the option, and the financial derivative product comes to have a game quality, rather than simply leaving the purchase up to the financial institution, and thus becomes more interesting.

Furthermore, as explained in connection with the first and second characteristics described above, even if the client's prediction is off and the funds for investing are lost without being able to exercise the right, the investment principal, for example, is not diminished, and it is possible to produce an extremely large profit if the client's predictions are accurate again and again. Accordingly, it becomes possible to draw clients who conventionally place value on stability and do not show much interest in high return financial products as users of the financial derivative product.

Next, explanation will be made of the basic concepts of financial derivative products which are managed by the investing method, the device for investing, etc. of the present invention.

The investing method according to the present invention begins with the client entrusting the investment principal to a financial institution, that is, a request that the financial institution manages the capital. Then, the financial institution applies (or obtains) interest to the entrusted investment principal (which may be a fixed term deposit, for example). According to the investing method of the present invention, this interest is used as funds for investing (explained in detail below) for the purchase of financial options, commodities options and the like.

In other words, at the time of purchase of the financial derivative product, for example, the client predicts a predetermined phenomenon on a predetermined date within a predetermined period, such as whether an exchange rate will rise or fall on a predetermined date after the lapse of a predetermined number of days, as compared to the exchange rate on a reference date. Then, the option based on this prediction is purchased, which is to say that in the case of a prediction that the exchange rate will rise, an option on a high exchange rate is purchased, and in the case of a prediction that the exchange rate will drop, an option on a low exchange rate is purchased. When the client purchases the option and exercises this right, the financial institution has an obligation to pay the client as warranted by the exercise of the right.

Note that according to the present invention, the option purchase based on this prediction is performed repeatedly on a predetermined cycle (at the end of every month, for example) during the predetermined period. If the prediction is on target each time again and again, then great profits can be obtained. On the other hand, if the predictions miss the target, then the client loses the funds for investing which were appropriated for the purchase of the option. However, the funds for investing, as will be explained in detail below, are comprised only of interest and profits. Accordingly, the investment principal which was entrusted to the financial institution in the beginning is guaranteed.

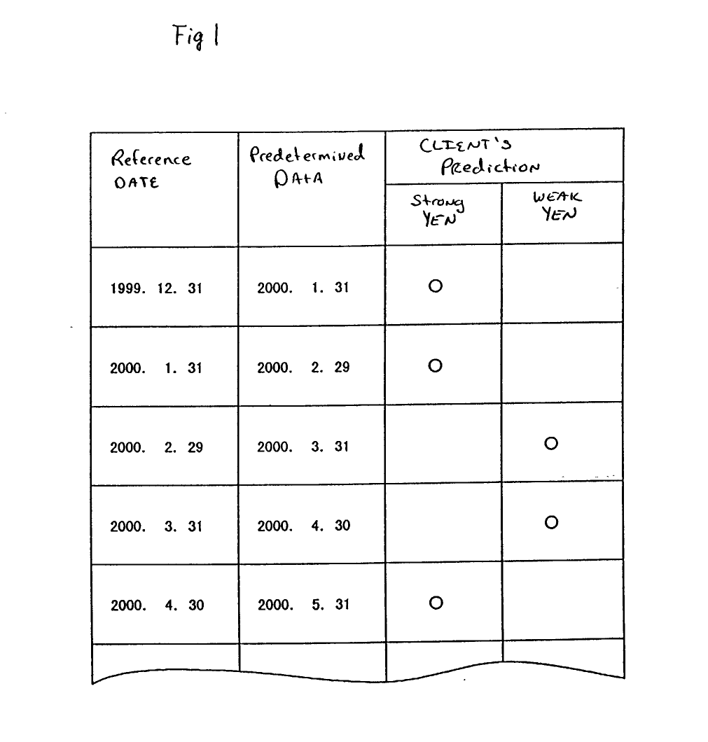

Hereinafter, more detailed explanation will be made of concepts of the investing method according to the present invention, making reference to FIGS. 1-4F. FIG. 1 is a diagram for explaining one example of client's predictions which form the basis of the option purchase. FIG. 2 is a chart depicting fluctuations in the funds for investing and profits during the predetermined period in the case when the funds for investing are comprised of both all of the interest and all of the profits. FIG. 3 is a chart depicting fluctuations in the investment principal, the interest, the funds for investing and the profits on each of predetermined dates during the predetermined period in the case when all of the interest (monthly interest) on the funds for investing and also the profits obtained through each option purchase are incorporated into the investment principal. FIGS. 4A to 4F are diagrams depicting the relationships among the investment principal entrusted by the client to the financial institution, the interest applied to the investment principal by the financial institution, and the funds for investing appropriated for the option purchases; this diagram is primarily for explanation of the funds for investing.

FIG. 1 is a diagram for explaining basic concepts relevant to a case when the option purchased by the client is a currency option. Note that the example of the currency option below is an example of a call/put digital option (i.e., cash or nothing) on a weak Yen/strong Yen. In other words, in the case of this option, the client predicts whether the exchange rate of Japanese Yen against the US Dollar will be higher or lower on a predetermined date as compared to the exchange rate on a reference date, and the purchase is made based on this prediction.

This call/put digital option (i.e., cash or nothing) is structured such that if the client's prediction hits the target on the predetermined date then the client can exercise the right on this purchased option, and accordingly, the client can receive approximately twice the sum of the invested sum. Note that the funds for investing appropriated for the costs of purchasing this option are of a variety of types, as shown in FIG. 2, FIG. 3 and FIGS. 4A to 4F; however, the funds for investing are mainly interest from the investment principal entrusted by the client to the financial institution, for example.

Note that the options purchased in the financial derivative product which uses the investing method of the present invention are not limited to the digital option (i.e., cash or nothing) described above, but are all varieties of financial options such as stock options, interest rate options and other currency options. Financial options are comprised of two kinds, plain vanilla options and exotic options. All options except for plain vanilla options are exotic options. There are many varieties of exotic options, and representative examples thereof are the digital options (i.e., the cash or nothing) mentioned above, digital options AON (i.e., asset or nothing), average options, look back options and barrier options, for example. All of these can be used as the options which are purchased in the financial derivative product using the investing method of the present invention. Further, not only financial options but also many varieties of commodities options such as precious metals options and grains options can be used as the options purchased in the financial derivative product using the investing method of the present invention.

Further, in the example explained hereinafter, the client predicts whether the exchange rate of Japanese Yen against the Dollar on a predetermined date will be higher or lower; however, the predicted object is not necessarily limited to this. For example, TOPIX, Nikkei, Dow and NASDAQ for example, or any of the variety of exchange rates, financial indicators and financial futures indicators for example, or any of the values assigned to financial products which are made available as objects of investment by the public can be used. Furthermore, it is also possible to change the index being used during the course of the continuous investments. In other words, prediction of the Yen/Dollar exchange rate can be used for the first prediction, and then prediction of the Dollar/Euro exchange rate can be used for the subsequent prediction.

Further, options can be used for the option purchased in the financial derivative product which uses the investing method of the present invention on both the over-the-counter market, of course, and the listed market, regardless of whether that option is a domestic option or an overseas option. For example, even options such as those listed in markets such as the CBOE (Chicago Board Option Exchange) and the CME (Chicago Mercantile Exchange) can be used for the option purchased in the financial derivative product which uses the investing method of the present invention.

In the example depicted in FIG. 1 which is an example of a purchase of a call/put digital option (i.e., cash or nothing), the client's prediction for the first predetermined date is that the Yen exchange rate against the Dollar on a predetermined date of Jan. 31, 2000 will be stronger than the exchange rate of the Yen on a reference date of Dec. 31, 1999. A second prediction for a predetermined date is that the Yen exchange rate against the Dollar on a predetermined date of Feb. 29, 2000 will be stronger than the exchange rate of the Yen on a reference date of Jan. 31, 2000. A subsequent prediction is that the Yen exchange rate against the Dollar on a predetermined date of Mar. 31, 2000 will be weaker than the exchange rate of the Yen on a reference date of Feb. 29, 2000. A further subsequent prediction is that the Yen exchange rate against the Dollar on a predetermined date of Apr. 30, 2000 will be weaker than the exchange rate of the Yen on a reference date of Mar. 31, 2000, and a subsequent prediction thereafter is that the Yen exchange rate against the Dollar on a predetermined date of May 31, 2000 will be stronger than the exchange rate of the Yen on a reference date of Apr. 30, 2000.

In this way, the client determines at the time of purchase of the financial derivative product, for example, predictions for each predetermined date during the predetermined period (which may be, for example, a period of one year). In other words, options are purchased. Note that in this example all of the call (weak Yen) and put (strong Yen) predictions were determined for each predetermined date during the predetermined period at the time of purchase of the financial derivative product. However, the present invention is not limited to this timing. For example, it is also possible to determine a prediction for the first predetermined date at the time of when the purchase request for the financial derivative product is performed, and then determine the prediction for the second and further subsequent predictions when the times come, which is to say before a certain period of time before each given predetermined date. Furthermore, it is possible to perform the prediction for the first predetermined date not at the time of the purchase of the financial derivative product, but after performing the purchase request and before a certain period of time before the first predetermined date.

Further, in the present example, the prediction of the calls (weak Yen) and the puts (strong Yen) on each of the predetermined dates were determined in comparison to reference dates, of which each is the previous predetermined date. However, the present invention is not limited to using such reference dates. In other words, if the reference date is a date being before the predetermined date on which the option is purchased, then the reference date can be set at will. For example, it is also possible to have the reference date be the date of the purchase request for the financial derivative product. Further, as an example, it is possible for the call (weak Yen) and put (strong Yen) predictions for all the predetermined dates after the first predetermined date to be determined in reference to the exchange rate on the same reference date (for example Dec. 31, 1999).

Next, detailed explanation will be made using FIG. 2, FIG. 3 and FIGS. 4A to 4F regarding the funds for investing appropriated for the costs of the option purchases described above made based on the client's predictions.

When the investment principal is entrusted to the financial institution by the client as capital for the purchase of the financial derivative product which uses the investing method, the financial institution applies interest to this investment principal. As an example, if the investment principal is US $100,000 and the interest rate set by the financial institution is an annual percentage rate of 3.60%, then that interest is US $3600 in 1 year and US $300 in 1 month. Further, as another example, if the investment principal is JPY (Japanese Yen) 10,000,000 and the interest rate set by the financial institution is an annual percentage rate of 0.48%, then that interest will be JPY 48,000 in 1 year and JPY 4000 in 1 month. In other words, the client entrusts the investment principal to the financial institution for a predetermined period (during which the client does not touch the investment principal), whereby the client can receive corresponding interest.

Note that the investment principal can be anything which generates interest or profits, such as any type of national currency, funds for purchasing commodities, funds for purchasing bonds, funds for purchasing securities, or funds for purchasing stocks. Further, the foregoing explanation has been made based on a premise that the client has entrusted the financial institution with funds for a fixed deposit, for example, which is to become the investment principal, and that the interest therefrom is used to purchase the options. However, the client can also purchase the options using a loan which is secured by the investment principal.

Note that in the following explanation the contract period for the financial derivative product (i.e., the period during which the capital is managed by the purchase of the options) is 1 year (12 months), and the dates for which the options are set (i.e., the predetermined dates) are each at the end of a month; however, the present invention is not limited to this. For example, the contract period can be set at 1 month, one half of a year, or such as is appropriate. Further, as another example, the predetermined dates on which the options are set can also be dates which occur, for example, one day after the next, or once per week, etc. Furthermore, it is possible for this cycle to occur irregularly rather than at periodic intervals. For example, the first predetermined date can occur after 10 days have elapsed, and then the second predetermined date can occur 30 days thereafter. Note that for purposes of management, it is desirable that the predetermined dates occur at regular, periodic intervals and that the contract period be an integer multiple of this regular interval (i.e., the cycle).

Further, as will be explained hereinafter, the funds for investing can be of a variety of types, such as all or a part of a sum of interest (annual interest or monthly interest) and a combination of one of these plus profits. A construction is also possible as a system in which the client can select from among these the funds which are to become the funds for investing. Further, the financial institution can select funds in advance which can be used as the funds for investing and then line these up as a type of product.

In other words, the client can select funds for investing from product types such as the following:

1. A part of the interest applied by the financial institution to the investment principal invested by the client, as shown in FIG. 4A;

2. All of the interest applied by the financial institution to the investment principal invested by the client, as shown in FIG. 4B;

3. Divided funds comprised of a part of the interest applied by the financial institution to the investment principal invested by the client which is divided according to a number of instances of options purchases, as shown in FIG. 4C;

4. Divided funds comprised of all of the interest applied by the financial institution to the investment principal invested by the client which is divided according to a number of instances of options purchases, as shown in FIG. 4D;

5. A combination of a part of the interest applied by the financial institution to the investment principal invested by the client, plus a part of the investment principal, as shown in FIG. 4E;

6. A combination of divided funds comprising all interest applied by the financial institution to the investment principal invested by the client which is divided according to a number of instances of option purchases, plus a part of the investment principal, as shown in FIG. 4F;

7. A combination of a part or all of the profits obtained by exercising a right on an option, plus one of (1)-(4) above;

8. A combination of a part or all of the profits obtained by exercising a right on an option, plus one of (5)-(6) above;

9. An appropriate combination of (1)-(8) above.

The financial institution does not need to prepare all of the above types. The financial institution may prepare only 2-4 types, for example, and the client can select freely from among these. Even though one of the above choices or another choice is selected, the investment principal or a part thereof decided by a selection by the client is not appropriated for the option purchase costs. Note that depending on what the funds for investing are used for, the ratio of the obtained profits to the investment principal varies across a wide range. The financial institution can position these as product types, separately according to each investment fund.

Next, detailed explanation will be made of each of the product types (i.e., types of funds for investing) mentioned above.

First, among the product types which use the investing method of the present invention, there are two which the Applicant considers to be optimal. Explanation will be made of each of these using FIG. 2 and FIG. 3. These two types can guarantee the principal, and also, are relatively highly profitable.

The interest explained in each of the examples hereinafter is generated by entrusting an investment principal to a financial institution for a predetermined period. Therefore, typically, the investment principal is entrusted to the financial institution, and when at least 1 month or more has elapsed, an option is purchased. However, for example, when payment interest that is due to accrue after one month, for example, is accelerated, namely when interest has not accrued, it is possible to make arrangements for the investment to be made first.

First, explanation will be made of the first product type. As mentioned in (7) above, it is possible to add a part or all of profits obtained by exercise of the option right and the funds for investing of any one of (1) to (4). Hereinafter, explanation will be made of a representative example as a first product type in which the funds for investing are comprised of a combination of all interest being divided according to a number of instances of option purchases [explained hereinafter as interest (i.e., monthly interest)] plus all profits.

FIG. 2 is a chart depicting fluctuations in funds for investing and profits on each predetermined date in the case of the first product type for purchasing options, using profits obtained by exercising option rights and using interest as the funds for investing. Note that in the first product type depicted in FIG. 2 all profits and interest (i.e., monthly interest) are appropriated for the cost of purchasing the options; however, it is also possible to use only a part of the profits and the interest.

Further, it is also possible to make arrangements so as to be able to change the funds for investing during the course of the investments. For example, it is possible to appropriate all of the interest and profits for funds for investing at first, and then start appropriating only a part thereof for funds for investing during the course of the investments. Further, it is possible to have the ratio of the sum which is to be used for the funds for investing (i.e., the portion that the interest used for the funds for investing occupies among the total interest, for example) fluctuate. For example, it is also possible to do something such as having a part of the profits and interest be used for the funds for investing in the beginning, and then when a certain amount of profits have been obtained this can be incorporated into the principal so as to increase assets.

As described above, in the first product type depicted in FIG. 2, a combination of all profits plus divided funds (i.e., being monthly interest) comprised of all interest (i.e., annual interest) divided according to the number of instances of option purchases (i.e., 12 in this example) is used for the costs of purchasing the options on each of the predetermined dates as the funds for investing. In FIG. 2, the monthly interest is 1R. Therefore, this sum 1R is invested and the profits obtained when this investment succeeds are an amount 2R which is double that of the monthly interest (i.e., 1R).

First, the option on the first predetermined date (for example, Jan. 31, 2000) is purchased using the interest 1R (indicated as monthly interest in this example and hereinafter) as the funds for investing. In the case when this investment succeeds, the client can receive profits of a sum of twice (2R) that of the invested capital, by exercising a right pertaining thereto. In the case when the investment does not succeed, the right cannot be exercised and the invested capital disappears.

Next, in the case when the first investment succeeds, an option is purchased again which is for the second predetermined date (for example, Feb. 29, 2000) using as the funds for investing a sum (3R) which is a combination of the interest (1R) and the profits (2R) obtained on the first predetermined date. In the case when this investment succeeds, the client receives a multiple amount (6R) of the invested capital by exercising the right thereto. In the case when this investment does not succeed the right is not exercised, and the capital invested this time (3R) is lost.

Next, in the case when the second investment succeeds, the option is purchased again which is for the third predetermined date (for example, Mar. 31, 2000) using as the funds for investing a sum (7R) which is a combination of the interest (1R) and the profits (6R) obtained by means of the second option purchase. In the case when this investment succeeds, the rights are exercised and the client receives a multiple amount (14R) of the invested capital again. In the case when the investment does not succeed, the rights can not be exercised and the capital invested this time (7R) is lost.

In this way, in the case when the investment succeeds, an operation is repeated in which an option is purchased using a combination comprised of profits resulting from exercising rights and interest up to the subsequent predetermined date (i.e., which is monthly interest in the above-mentioned case) as the funds for investing. In this first product type, as shown in FIG. 2, in the case when the investment succeeds for three times consecutively, 15R is invested and there is a chance of obtaining 30R and, in the case when the investment succeeds for four times consecutively, 31R is invested and there is a chance of obtaining 62R. The arrangement is such that as success continues after this point, it is possible to obtain a sum which is at least twice the sum of the profits from the previous time every time.

Then, when investment succeeds for 12 consecutive times during the course of a one year contract period, it is possible ultimately to obtain interest (i.e., monthly interest) which is of 8,190 times the amount, as shown in FIG. 2. Note that this first product type depicted in FIG. 2 is calculated on the basis that the investment principal is US $100,000, the contract period is for one year, the option purchase cycle is one month, and the interest rate (i.e., monthly interest) applied for the client is 0.30%=US $300. Accordingly, the profits will be 2,457% of the investment principal (i.e., US $100,000), which is US $2,457,000 [i.e., 0.30% (i.e., monthly interest)×8,190]. Therefore, the combination of these profits plus the $100,000 investment principal which is guaranteed to be paid back at the time of the end of the contract is a sum of US $2,557,000 which is to be paid back to the client at the time of the end of the contract.

In other words, in the case of the fist product type described above, if every predetermined date throughout the predetermined period (i.e., the contract period) becomes the date on which the option right can be exercised so that the investments (i.e., the option purchases) succeed, then the investment of US $100,000 will enable an extremely high return of US $2,557,000 to be received at the time of maturity. Note, however, that if option rights cannot be exercised the very last time (which is the 12th time in this example number 7), then all of the profits received to that point are lost.

However, even in the unlikely event that all of the profits are lost, the investment principal can be received at the time of maturity. That is, the return of the investment principal is guaranteed. Further, in the case of the first product type described above, the purchases of the options on each of the predetermined dates during the given period are repeated; therefore, if an option right can be exercised at least the last time (i.e., the 12th time) then some amount of profit will be obtainable.

For example, in a case when the first option purchase fails but all of the option purchases succeed thereafter, which is to say the case when the option rights could be exercised for the remaining eleven times after the first time, the client can receive profits which are 4,094 times the interest (i.e., the monthly interest).

Also, even in a case when the first purchase through the eleventh purchase all fail consecutively but the last twelfth option purchase time succeeds, the client can receive profits which are twice (i.e., 2R) the interest (1R).

Note that in the case of this first product type, as described above, the investment is consecutively repeated until the last of the predetermined dates; however, it is also possible, for example, for the client to make a request whereby the investing (i.e., the purchasing of the options) is stopped during the course of the investments. Further, it is possible to establish a clause describing a special policy condition to the effect that when the investment (i.e., the option purchases) is consecutively successful for five times the profits which have been obtained to that point are pooled. Additionally, it is possible to establish clauses describing special policy conditions to the effect that in the case when the profits exceed a certain sum, and in the case when the profits exceed a certain ratio of the investment principal, for example, the profits obtained to that point are pooled.

When a clause is set describing special policy conditions in this way, after the above-described actions are performed (i.e., after the client requests a stop of the purchasing or after performing the pooling), the risk of losing the funds for investing disappears. Note, however, that the financial institution may set a certain sum as a breech of contract fee for this request to stop purchasing funds.

Next, explanation will be made of a second product type depicted in FIG. 3.

In addition to the product types listed in (1)-(9) above, it is also possible to incorporate into the investment principal a part or all of profits obtained from exercising the option rights. That is, it is possible to enlarge the investment principal by incorporating into the investment principal profits obtained through the exercising of option rights. In this way, the financial institution can reapply interest to the enlarged investment principal. If the interest rate applied at this time is the same as the interest rate from the time of the purchase then, of course, the sum of the interest will increase. A part or all of this increased interest can be appropriated for the purchase of the option on the subsequent predetermined date.

Note, that it is possible to use a part or the entire sum of the increased interest as funds for investing for purchasing the options on each of the predetermined dates. Further, as funds for investing for the cost of purchasing the options on each of the predetermined dates, it is also possible to use divided funds comprised of a part of or all of the sum of the increased interest, being further divided according to the number of times (i.e., instances) that option purchases will be performed during the course of the contract period. Additionally, it is also possible to use a combination of a part or all of the sum of the increased interest, plus a part of the expanded investment principal (or un-expanded principal, since profits are needed to expand the principal) as funds for investing for the cost of purchasing the options on each of the predetermined dates.

Furthermore, it is also possible to use as funds for investing for the cost of purchasing the options on each of the predetermined dates a combination of a part or all of the increased sum of the interest being further divided according to the number of times (i.e., instances) that option purchases will be performed during the course of the contract period, plus a part (or a portion of this part being further divided according to the number of instances of the option purchase during the course of the contract period) of the expanded investment principal 2 (or un-expanded principal, since profits are needed to expand the principal). That is, it is possible to apply all of the product types described above onto the structure in which the profits are incorporated into the investment principal.

FIG. 3 is a chart depicting the status of the investment principal, the interest, and the funds for investing and profits in the case of the second product type, which is a representative example of repetition of the investment (i.e., the option purchase) while growing the investment principal and the interest by means of incorporating into the investment principal the profits obtained through investing (i.e., purchasing options).

In FIG. 3, which explains the second product type, P represents the investment principal in the state in which the investment principal has not grown at the time of when the request for purchase of the financial derivative product is performed (i.e., the investment principal at the very beginning), and the starting interest 12R (i.e., annual interest) is applied to the starting investment principal P. The starting interest 12R is divided according to the number of instances of options purchases (i.e., being 12 in this example). These divided funds 1R (i.e., being monthly interest in the present example) become the funds for investing for the first option purchase. Note that in the second product type depicted in FIG. 3, all of the interest (i.e., monthly interest) is appropriated for the cost of option purchase; however, it is also possible to appropriate only a part of the interest for the option purchase cost.

Further, it is also possible to have the funds for investing change during the course of the investments. For example, it is possible to have the entire sum of the interest appropriated for use as the funds for investing at first, and then have only a part thereof be appropriated for funds for investing during the course of the investments. Further, the portion that is used as funds for investing (i.e., the ratio of the interest to be used as funds for investing to the total sum of the interest, for example) can be made to fluctuate.

In this second product type, divided funds (1R) from the starting interest 12R described above are used for the purchase of an option having a first predetermined date (for example, Jan. 31, 2000) as the date on which the option rate is to be exercised. Note that this is the first investment (option purchase), so of course no profits have been obtained; therefore, the column used in FIG. 3 in which the “number of times profits have been incorporated into the principal” is 0 is referenced. As shown in this column, in the case when the first investment succeeds the rights can be exercised and an amount of two times the funds invested (2R) can be obtained as profits.

These profits 2R are incorporated into the starting investment principal P. As a result, as shown in FIG. 3 in the column in which the “number of times profits have been incorporated into the principal” is 1, the starting investment principal P has the first profits 2R incorporated therein and expands to an investment principal P1 (i.e., P+2R). Accordingly, the financial institution can set interest anew based on the investment principal P1. This interest becomes a sum of interest 12R1 which has expanded (i.e., grown) due to the growth of the investment principal. On the other hand, in the case when the first investment (i.e., option purchase) does not succeed, the right cannot be exercised and the invested capital (i.e., the first divided funds 1R) disappears.

Furthermore, in a case such as this when the investment does not succeed the invested capital is lost and, of course, no profits can be received. Accordingly, profits cannot be incorporated into the investment principal. Therefore, if FIG. 3 is to be referenced upon the subsequent investment, then the “number of times profits have been incorporated into the principal” should not be increased, and the same column should be referenced once again. Specifically, in the case when the first investment (i.e., option purchase) does not succeed, the column in which the “number of times profits have been incorporated into the principal” is 0 should be referenced once again upon the second investment. Note that this condition applies in all of the investments (i.e., option purchases) including and following the second purchase, which are to be explained below.

Next, in the case when the first investment succeeds, divided funds (1R1) from the expanded interest 12R1 are used for the second purchase of an option set for the second predetermined date (for example, Feb. 29, 2000). Note that this is the second investment (i.e., option purchase) and includes the profits 2R from the first investment incorporated into the investment principal P; therefore, reference is to be made to the column in FIG. 3 in which the “number of times profits have been incorporated into the principal” is 1. As shown in this column, in the case when the second investment succeeds, the rights are exercised and a sum of twice the invested capital (2R1) can be received as profits.

These profits 2R1 are incorporated into the investment principal P1. As a result, the investment principal P1 has the profits 2R1 from the second time incorporated therein and expands to an investment principal P2 (i.e., P1+2R1). Accordingly, the financial institution sets interest anew based on the investment principal P2. This interest becomes a sum of interest 12R2 which has expanded (i.e., grown) due to the growth of the investment principal. On the other hand, in the case when the investment does not succeed the rights cannot be exercised and the capital invested this time (1R1) disappears.

Next, in the case when the second investment succeeds, divided funds (1R2) from the expanded interest 12R2 are used for the third purchase of an option set for the third predetermined date (for example, Mar. 31, 2000). Note that this is the third investment (i.e., option purchase) and includes the profits 2R, 2R1 from the past two investments incorporated into the investment principals P, P1 respectively; therefore, reference is to be made to the column in FIG. 3 in which the “number of times profits have been incorporated into the principal” is 2. As shown in this column, in the case when the third investment succeeds the rights are exercised and a sum of twice the invested capital (2R2) can be received as profits.

These profits 2R2 are incorporated into the investment principal P2. As a result, the investment principal P2 has the profits 2R2 from the third investment incorporated therein and expands to an investment principal P3 (i.e., P2+2R2). Accordingly, the financial institution sets interest anew based on the investment principal P3. This interest becomes a sum of interest 12R3 which has expanded (i.e., grown) due to the growth of the investment principal. On the other hand, in the case when the investment does not succeed the rights cannot be exercised and the capital invested this time (1R2) disappears.

In this way, in the second product type described above, in the case when the investment succeeds, the profits obtained through the exercise of the option right are incorporated into the investment principal and the investment principal grows. Accordingly, the sum of the interest on the investment principal also grows. Then, the increased interest is used as funds for investing to purchase an option which is set for the subsequent predetermined date. This operation is repeated.

Note that in this second product type, as shown in FIG. 3, when everything succeeds at the eleventh investment the profits 2R, 2R1 . . . 2R10 from the past eleven investments are each incorporated in the investment principals P, P1 . . . P10 respectively. (Reference is to be made to the column in FIG. 3 in which the “number of times profits have been incorporated into the principal” is 11.) As indicated in this column, in the case when the last investment succeeds, the rights are exercised and a sum (2R11) which is twice the amount of the invested capital can be received as profits. On the other hand, in the case when the investment does not succeed the rights cannot be exercised and the capital invested this time (1R11) disappears.

In other words, according to the second product type described above, if all of the option purchases on each of the predetermined dates during the given period (i.e., the contract period) succeed, then the profits 2R, 2R1 . . . 2R10 from the first to eleventh investments are consecutively incorporated into the investment principals P, P1 . . . P10, and the sums of interest which are set on the increased investment principals are consecutively allotted for the investments (i.e., the option purchases). Accordingly, this second product type is potentially an extremely high return product, just like the first product type described above, such that when the investments in the options continue to succeed consecutively, an extremely large profit can be obtained at the time of maturity.

Note, however, that in the case of this second product type the profits obtained through the option purchase are incorporated into the investment principal. Accordingly, when the profits are obtained the investment principal grows (increases in amount). Therefore, in the case of this second product type, even if the investment does not succeed successively the profits from the investments which did succeed are incorporated into the investment principal, and at the time of maturation the investment principal has grown by the amount of the profits which have been obtained. When the last investment does not succeed the client cannot exercise option rights on in the final investment, and cannot obtain profits from this final investment; however, the profits until that point have been incorporated into the investment principal, so the client can receive a payment of this increased investment principal on the maturation date. Therefore, the client can receive an investment principal which has grown larger than the starting investment principal by an amount equal to the profits which have been obtained, whereby the client can reap a financial gain.

In this way, in the present example, regardless of whether the investment on the final time succeeds or not, regardless of whether the investments succeed successively one after the other or not, and also regardless of which time the investment succeeded, an increased investment principal can be received at the time of maturation. In other words, in any case when the investment has succeeded at least once, the payment of an increased investment principal is guaranteed. Note that, of course, even if the investment does not succeed even once the payment of the investment principal P invested in the beginning is guaranteed.

The first and second types described above are similar to each other in that the interest (i.e., monthly interest) that is applied to the investment principal is used as the first funds for investing, and after that point there is a possibility of rapidly growing the funds for investing, and a possibility of rapidly growing the profits obtained through those investments.

Next, explanation will be made of product types which differ from the two types described above, making use of FIGS. 4A to 4F.

As shown in FIGS. 4A to 4F, when the client entrusts the investment principal 2 to the financial institution as capital for the purchase of financial derivative products which use the present investing method, the financial institution applies interest 3 (note that the interest depicted in FIGS. 4A to 4F is annual interest) to the investment principal 2.

In FIG. 4A a third product type is shown in which a part of the interest 3 applied by the financial institution to the investment principal 2 invested by the client is appropriated for use as funds for investing 5 for the costs of purchasing the option on the predetermined date. That is, the third product type shows that a part 3a of the interest 3 is appropriated as capital for option purchases on predetermined dates during the given period. The example shown indicates a case in which the investment principal 2 is US $100,000, and half (US $1800) of the interest 3 of US $3600 is appropriated as capital for option purchases on each predetermined date (i.e., the end of each month) during the given period (i.e., 12 months in the present embodiment).

On the other hand, when the client purchases the financial derivative product 1 a prediction is determined regarding a given phenomenon on a predetermined date. That is, as shown in FIGS. 4A to 4F, a prediction is determined for a call (i.e., weak Yen) or a put (i.e., strong Yen) on each of the predetermined dates during the given period (i.e., of 12 months), for example. Further, the financial derivative product 1 is a fixed term deposit from which the interest 3 is used to purchase options, so an arrangement is possible in which, for example, cash can not be withdrawn from the investment principal 2 during the period during which options are to purchased (i.e., 12 months in the present example).

In the case of the third product type shown in FIG. 4A, a part 3a of the interest 3 is all appropriated for the option purchases on each of the predetermined dates. Therefore, when the option purchase set for the first predetermined date succeeds, the client can obtain a corresponding profit (i.e., of twice the amount invested). When the client's first investment (i.e., option purchase) succeeds, the part 3a of the interest 3 which is set on the investment principal 2 is then appropriated once again on the date of the second option purchase at the end of the subsequent month. Therefore, when the option purchase on the second predetermined dates succeeds, the client can obtain corresponding profits once again (i.e., of twice the amount invested). In this way, as long as the investments (i.e., the option purchases) succeed, the part 3a of the interest 3 from the investment principal 2 is appropriated on the date of the option purchase as capital for the purchase.

Then, when the investment (option purchase) on the twelfth option purchase date at the end of the contract period succeeds, which is to say that all of the first through twelfth investments (option purchases) have succeeded successively one after the other, the client can obtain correspondingly large profits.

Note that in the third option type depicted in FIG. 4A, the entirety of the funds for investing 5 (which is the entirety of the part 3a of the interest 3) is appropriated for the option purchases every time. Therefore, if there is even one instance during the course of the investments when an investment (option purchase) fails to succeed (including the first investment), then the client loses the entirety of the funds for investing 5 at that point. Accordingly, the client cannot participate in subsequent investments (option purchase).

However, in the case of this third product type depicted in FIG. 4A, the investment principal 2 (US$100,000) and remainder 3b of the interest 3 (i.e., the remainder being US$1800 according to the example described above) are not used in the funds for investing 5. Therefore, of course, there is no financial loss with regards to the investment principal 2 and the remainder 3b from the interest 3, and the client can have these paid back in entirety as desired upon maturity of the contract.

Further, in the case of the third product type depicted in FIG. 4A, if the investments (option purchases) up to a given point have succeeded successively one after the other and profits from the same have been obtained, then these profits remain in the possession of the client. Further, it is possible for the client to receive the profits obtained from each investment (option purchase) in cash from the financial institution, or it is also possible to have the financial institution transfer the profits into the client's account in which the investment principal 2 is invested (i.e., since there are cases in which a fixed deposit account provides the principal). In the case when the profits are incorporated into the investment principal 2 during the course of the investments, the interest 3 increases from that point; therefore, the sum of investments made after that point increase. In situations such as this, the profits which are obtained through the investments (option purchase) made after that point also grow larger.

Further, as described above, with this third product type the investments are repeated successively one after the other until the funds for investing 5 are lost [i.e., while the investments (option purchases) are successful] or until these successful investments reach the last option purchase date; however, it is also possible to stop the investments (option purchases), for example, by means of a request from the client. In this situation the client's risk of the investments (option purchases) not succeeding and losing the part 3a of the interest 3, which is the funds for investing, being lost disappears after this point. Note that it is also possible for the financial institution to apply a breech of contract fee of a given amount to such a request by the client to stop the investments before completion of the contact period.

Explanation will now be made of the third product type depicted in FIG. 4A using more specific figures.

First, an option on a first predetermined date (for example, Jan. 31, 2000) is purchased with the part 3a of the interest 3 described above (i.e., US $1800). In the case when this investment succeeds the option rights can be exercised and an amount of twice the capital invested (i.e., US $3600) can be received. In the case when the investment does not succeed the rights cannot be exercised, the invested capital disappears and subsequent options cannot be purchased thereafter.

Next, in the case when the first investment succeeds an option for the second predetermined date (for example, Feb. 29, 2000) is purchased with the part 3a of the interest 3 described above (i.e., US $1800). In the case when this investment succeeds the option rights are exercised and profits of twice the invested amount (i.e., US $3600) are received once again. Accordingly, the client receives profits of US $7200 in total, which includes the profits from the previous two investments. In the case when the investment does not succeed the rights cannot be exercised, the invested capital disappears and subsequent options cannot be purchased thereafter. In this situation the US $3600 received by the client from the previous investment become the profit which the client has gained with this financial derivative product. Of course, at the end of the contract period the investment principal 2 and the part 3b of the interest 3 which have not been appropriated for the costs of the options purchases can be paid back.

Note that the investments are repeated in the same way subsequently during the duration of the contract period (which is 1 year in this example). Accordingly, when the investments succeed every time during the contract period the client can ultimately receive profits of US $43,200 in addition to the investment principal 2. With this third product type, profits which have been obtained through the previous investments are not used in the funds for investing 5; therefore, these profits remain in possession of the client.

FIG. 4B depicts a fourth product type in which the entirety of interest 3 applied by the financial institution to the investment principal 2 invested by the client is used as the funds for investing 5. In other words, the fourth product type indicates the appropriation of all of the interest 3 (i.e., annual interest) as capital for the option purchases on each of the predetermined dates during the given period. As an example, FIGS. 4A to 4F indicate a case in which the investment principal 2 is US $100,000, and the interest 3 (US $3600) is appropriated as capital for the option purchases on each of the predetermined dates (i.e., at the ends of each month) during the given period (which is 12 months in the present embodiment).

In the case of the fourth product type depicted in FIG. 4B the interest 3 is appropriated in its entirety for use as the capital for the option purchases on each of the predetermined dates. Therefore, when the option purchase on the first predetermined date succeeds the client can obtain corresponding profits (i.e., twice the capital invested). Further, in the fourth product type of FIG. 4B the invested capital is twice that of the invested capital in the third product type shown in FIG. 4A (i.e., in the third product type 50% of the interest 3 was invested, but in the fourth product type 100% of the interest 3 is invested); therefore, the profits are also twice that of those with the third product type described above.

Then, when the first investment (option purchase) succeeds the entirety of the interest 3 applied to the client's investment principal 2 is appropriated once again on the date when the second option is purchased at the end of the subsequent month for use as the capital for the purchase. Therefore, when the investment (option purchase) on the second option purchase date succeeds the client can receive corresponding profits once again (i.e., of twice the invested amount). The profits in this case too, of course, are twice that of those in the case of the third product type shown in FIG. 4A. As long as the investments (option purchases) succeed in this way the entirety of the interest 3 applied to the investment principal 2 will be appropriated on the option purchase date as capital for that purchase.

Then, when all of the predictions succeed up until that of the twelfth predetermined date, which is the end of the contract period, and all of the investments (option purchases) from the first through the twelfth succeed successively one after the other the client can obtain a correspondingly large profit. Note that the profits in this case are also, of course, twice that of those in the case of the third product type depicted in FIG. 4A.

Note that in the fourth option type depicted in FIG. 4B, the entirety of the funds for investing 5 (which is the entirety of the interest 3) is appropriated for the option purchases every time. Therefore, if there is even one instance during the course of the investments when an investment (option purchase) fails to succeed (including the first investment), then the client loses the entirety of the funds for investing 5 at that point. Accordingly, the client cannot participate in subsequent investments (option purchases).

However, in the case of this fourth product type depicted in FIG. 4B, the investment principal 2 (US $100,000) is not used in the funds for investing 5. Therefore, of course, there is no financial loss with regards to the investment principal 2, and the client can have this paid back in entirety as desired upon expiration of the contract.

Further, in the case of the third product type depicted in FIG. 4B, if the investments (option purchases) up to a given point have succeeded successively one after the other and profits from the same have been obtained, then these profits remain in the possession of the client.

Further, it is possible for the client to receive the profits obtained from each investment (option purchase) from the financial institution, or it is also possible to have the financial institution transfer the profits into the client's account in which the investment principal 2 is invested (i.e., since there are cases in which a fixed deposit account provides the principal). In the case when the profits are incorporated into the investment principal 2 during the course of the investments, the interest 3 increases from that point; therefore, the sum of investments made after that point increase. In situations such as this, the profits which are obtained through the investments (option purchase) made after that point also grow larger.

Further, as described above, with this fourth product type the investments are repeated successively one after the other until the funds for investing 5 are lost [i.e., while the investments (option purchases) are successful] or until these successful investments reach the last option purchase date; however, it is also possible to stop the investments (option purchases) before completion of the contract, for example, by means of a request from the client. In this situation the client's risk of the investments (option purchases) not succeeding and losing the interest 3, which is the funds for investing 5, being lost disappears after this point. Note, that it is also possible for the financial institution to apply a breech of contract fee of a given amount to such a request by the client to stop the investments before completion of the contract.

FIG. 4C depicts a fifth product type in which divided funds 3c, being comprised of a part 3a of the interest 3 divided into the number of instances of option purchases (12 in this example), are appropriated for use as the funds for investing 5 for the costs of purchasing the options on each of the predetermined dates. That is, the fifth product type indicates the appropriation of a part 3a of the interest 3 which is further divided into 12 parts, each of thus divided funds is used as the capital for the purchasing of the options on the predetermined dates during the given period.

As an example, a case is shown in which US $1800, which is 50% of the interest 3 (i.e., US $36000) from investment principal 2 of US $100,000 is divided by the number of occurrences of the predetermined dates (i.e., 12 times) during the given period (which is 12 months according to the present embodiment), and these divided funds (i.e., US $150) are appropriated for use as capital for the purchase of options on each of the predetermined dates.

Note that in the example of the fifth product type depicted in FIG. 4C, the divided funds 3c, which are comprised of the part 3a of the interest 3 being further divided into twelve equal parts, are appropriated for use as capital for the option purchases on each of the predetermined dates (i.e., for use as the funds for investing 5). That is to say that the funds for investing 5 are divided in the beginning by the number of times that options are to be purchased; therefore, in contrast to the third and fourth product types a system is provided in which even if the investments fail during the course of the investments and the option rights cannot be exercised the capital for purchasing options is not lost, and it is possible to invest the subsequent time. In this way the fifth product type has a characteristic that the purchase of options can be performed repeatedly in a continuous fashion on all of the predetermined dates during the contract period.

Therefore, if the investment (i.e., option purchase) on the first predetermined date is successful, the client can receive corresponding profits [i.e., the amount of the invested capital=US $150 times 2 (=US $300)]. On the other hand, however, in the case when the investment fails and the rights cannot be exercised the client loses an amount of the funds for investing divided by 12 (i.e., US $150). Then, this investment (option purchase) is repeated until the completion of the contract period, regardless of successes and failures during the course of the investments. As a result, if the number of times that the investments succeed is great, then the client can obtain correspondingly large profits.

Further, in a manner similar to that of the third product type, with the fifth product type depicted in FIG. 4C, the investment principal 2 (US $100,000) and the remainder portion 3b of the interest 3 (i.e., the remainder was US $1800 in the example described above) are not used in the funds for investing 5. Therefore, of course, there is no financial loss with regards to the investment principal 2 and the remainder 3b from the interest 3, and the client can have these paid back in entirety as desired upon expiration of the contract. Further, in the case of this fifth product type shown in FIG. 4C, the profits from the times when the investments (option purchases) succeeded remain with in the possession of the client.

Further, it is possible for the client to receive the profits obtained from each investment (option purchase) in cash from the financial institution, or it is also possible to have the financial institution transfer the profits into the client's account in which the investment principal 2 is invested (i.e., since there are cases in which a fixed deposit account provides the principal). In the case when the profits are incorporated into the investment principal 2 during the course of the investments, the interest 3 increases from that point; therefore, the sum of investments made after that point increase. In situations such as this, the profits which are obtained through the investments (option purchase) made after that point also grow larger.

Further, as described above, with this fifth product type the investments are repeated successively one after the other until the last predetermined date; however, it is also possible to stop the investments (option purchases), for example, by means of a request from the client. In this situation the client's risk of the investments (option purchases) not succeeding and losing the divided funds 3c, which are the funds for investing 5 for each of the investments, disappears after this point. Note, that it is also possible for the financial institution to apply a breech of contract fee of a given amount to such a request by the client to stop the investments before completion of the contract.

FIG. 4D depicts a fifth product type in which divided funds 3d (i.e., monthly interest in this example), being comprised of the entirety of the interest 3 applied by the financial institution to the investment principal 2 invested by the client further divided according to the number of instances of option purchases (i.e., 12 in the present example) are appropriated for use as the funds for investing 5 for the costs of purchasing the options on each of the predetermined dates. That is, the sixth product type indicates the appropriation of all of the interest 3 which is further divided into 12 equal parts, in which these divided funds are used as the capital for the purchasing of the options on the predetermined dates during the given period.

As an example, a case is shown in which the interest 3 (US $36000) from the investment principal 2 of US $100,000 is divided by the number occurrences of the predetermined dates (i.e., 12 times) occurring during the given period (which is 12 months according to the present embodiment), and these divided funds (i.e., US $300) are appropriated for use as capital for the purchase of options on each of the predetermined dates.

Note that in the example of the sixth product type depicted in FIG. 4D the divided funds 3d, which are comprised of the interest 3 being divided into twelve equal parts, are appropriated for use as capital for the option purchases on each of the predetermined dates (i.e., for use as the funds for investing 5). That is, in the same way as in the fifth product type described above, the funds for investing 5 are divided in the beginning by the number of times that options are to be purchased; therefore, in contrast to the third and fourth product types there is provided a system in which even if some of the investments fail during the course of the investments and the option rights cannot be exercised, the capital for purchasing options is not lost, and it is possible to invest the subsequent time.

Therefore, if the option purchase set for the first predetermined date is successful and the option right can be exercised, then the client can receive corresponding profits (i.e., twice that of the invested capital). On the other hand, however, in the case when the investment fails and the rights cannot be exercised, the client loses the amount of one portion of the funds for investing which have been divided into twelve equal portions. Then, this investment (option purchase) is repeated until the completion of the contract period, regardless of successes and failures during the course of the investments. As a result, if the number of times that the investments succeed is great, then the client can obtain correspondingly large profits.

Further, in a manner similar to that of the fourth product type described above, with the sixth product type depicted in FIG. 4D, the investment principal 2 (US $100,000) is not used as the funds for investing 5. Therefore, of course, there is not loss with regards to the investment principal 2 and the remainder 3b from the interest 3, and the client can have these paid back in its entirety as desired upon maturity of the contract. Further, in the case of this sixth product type shown in FIG. 4D, the profits from the times when the investments (option purchases) succeeded remain in the possession of the client.

Further, it is possible for the client to receive the profits obtained from each investment (option purchase) in cash from the financial institution, or it is also possible to have the financial institution transfer the profits into the client's account in which the investment principal 2 is invested (i.e., since there are cases in which a fixed deposit account provides the principal). In the case when the profits are incorporated into the investment principal 2 during the course of the investments, the interest 3 increases from that point; therefore, the sum of investments made after that point increases. In situations such as this, the profits which are obtained through the investments (option purchase) made after that point also grow larger.

Further, as described above, with this sixth product type the investments are repeated successively one after the other until the last predetermined date; however, it is also possible to stop the investments (option purchases), for example, by means of a request from the client. In this situation the client's risk of the investments (option purchases) not succeeding and losing the divided funds 3d, which are the funds for investing 5 for each of the investments, disappears after this point. Note that it is also possible for the financial institution to apply a breech of contract fee of a given amount to this sort of request by the client to stop the investments during the course of the investments.

FIG. 4E depicts a seventh product type in which a part 3a of the interest 3 set by the financial institution on the investment principal 2 invested by the client, plus a part 2a of the investment principal 2 (such as 10% of an investment principal of US $100,000, which would be US $10,000, for example) are appropriated for use as funds for investing 5 for the costs of purchasing the options on each of the predetermined dates. That is, this seventh product type indicates the appropriation of all of the funds for investing 5 that are used in the third product type described above (i.e., a part 3a of the interest 3), plus a part 2a of the investment principal 2 added thereto. Accordingly, the amount invested for the costs of the options purchases increases; therefore, the profits in the case when the investments succeed also increase.

On the other hand, however, if the investment does not succeed there develops a risk of losing the part 3a of the interest 3 and the part 2a of the investment principal 2; however, 90% of the investment principal 2 (i.e., US $90,000), which is the most of the remainder portion, plus the remainder portion 3b of the interest 3 are guaranteed to be repaid at the end of the contract period. Therefore, in the case of this seventh product type there is more of a risk of loss of the principal value than there is with the various product types described above; however, the scope of this risk is set from the beginning. Furthermore, it is possible to gain greater profits as compared to the product types described above.

Further, in the case of this seventh product type, the combination of the part 3a of the interest 3 together and the part 2a of the investment principal 2 are used for the funds for investing 5 for the costs of purchasing the options on the predetermined dates; however, it is also possible that a combination of the entirety of the interest 3 and the part 2a of the investment principal 2 is used as the funds for investing 5 for the costs of purchasing the options on the predetermined dates.

Further, it is possible for the client to receive the profits obtained from each investment (option purchase) in cash from the financial institution, or it is also possible to have the financial institution transfer the profits into the client's account in which the investment principal 2 is invested (i.e., since there are cases in which a fixed deposit account provides the principal). In the case when the profits are incorporated into the investment principal 2 during the course of the investments, the interest 3 increases from that point; therefore, the sum of investments made after that point increase. In situations such as this, the profits which are obtained through the investments (option purchase) made after that point also grow larger.

Further, as described above, with this seventh product type the investments are repeated successively one after the other until the last predetermined date; however, it is also possible to stop the investments (option purchases), for example, by means of a request from the client. In this situation the client's risk of the investments (option purchases) not succeeding and losing the funds for investing 5 for each of the purchases disappears after this point. Note that it is also possible for the financial institution to apply a breech of contract fee of a given amount to this sort of request by the client to stop the investments before completion of the contract.

FIG. 4F depicts an eighth product type in which divided funds 3d being comprised of the entirety of the interest 3 set by the financial institution on the investment principal 2 invested by the client which have been further divided according to the number of instances that options are to be purchased during the contract period, plus a part 2a of the investment principal 2 (such as 10% of an investment principal of US $100,000, which would be US $10,000, for example) are appropriated for use as funds for investing 5 for the costs of purchasing the options on each of the predetermined dates. That is, this eighth product type indicates the appropriation of all of the funds for investing 5 that are used in the sixth product type described above (i.e., the divided funds 3d created by dividing up the interest 3), plus a part 2a of the investment principal 2 added thereto. Accordingly, the amount invested for the costs of the options purchases increases; therefore, the profits in the case when the investments succeed also increase.

On the other hand, however, if the investment does not succeed there develops a risk of losing the part 2a of the investment principal 2; however, 90% of the investment principal 2, which is the most of the remainder portion is guaranteed to be repaid at the end of the contract period. Therefore, in the case of this eighth product type there is more of a risk of loss of the principal value than there is with the third through sixth product types described above; however, the scope of this risk is set from the beginning. Furthermore, it is possible to gain greater profits as compared to the third through sixth product types described above. Note that in FIG. 4F the part 2a of the investment principal 2 is not divided according to the number of instances in which options are to be purchased; however, it is also possible to further divide this part 2a of the investment principal 2, combine the divided funds 3a from the interest 3 with the divided funds from the investment principal 2, and use this combination for the cost of one options purchase.

Further, it is possible for the client to receive the profits obtained from each investment (option purchase) in cash from the financial institution, or it is also possible to have the financial institution transfer the profits into the client's account in which the investment principal 2 is invested (i.e., since there are cases in which a fixed deposit account provides the principal). In the case when the profits are incorporated into the investment principal 2 during the course of the investments, the interest 3 increases from that point; therefore, the sum of investments made after that point increase. In situations such as this, the profits which are obtained through the investments (option purchase) made after that point also grow larger.

Further, as described above, with this eighth product type the investments are repeated successively one after the other until the last predetermined date; however, it is also possible to stop the investments (option purchases), for example, by means of a request from the client. In this situation the client's risk of the investments (option purchases) not succeeding and losing the funds for investing 5 for each of the purchases disappears after this point. Note, that it is also possible for the financial institution to apply a breech of contract fee of a given amount to this sort of request by the client to stop the investments before completion of the contract.

Note that, as described above, with financial derivative products which use the investing method of the present invention, the client's investment principal (or 90% thereof, for example) is guaranteed to be paid back on the date of maturation, and yet there is a possibility of obtaining great profits.

Note that, for the funds for investing it is possible to use a combination of a part or all of the profits obtained through the exercise of option rights, plus the sources described in 5 or 6 above (i.e., which include the investment principal in the funds for investing). That is to say that this is a variation on the first product type, in which the funds for investing can be comprised of profits added together with either a combination of a part of the interest set by the financial institution on the investment principal invested by the client plus a part of the investment principal, or added together with a combination of the divided funds described in 6 above which are comprised of the entirety of the interest set by the financial institution on the investment principal invested by the client and being further divided according to the number of instances in which options are to be purchased, plus a part of the investment principal. Further, these product types have a characteristic that the amount of the funds for investing invested in the first investment is greater than that in the case of the first product type, so the amount of the profits and the amount of the funds for investing during the course of the investments are also greater. Note, however, that explanation of detailed sums and such aspects of the profits have been omitted here.

Further, as described in 9 above, it is possible for the client to combine sources described in 1-8 above as necessary and use these for the costs of the option purchases (i.e., as the funds for investing 5) for each of the predetermined dates.

On the other hand, the financial derivative products which use the investing method of the present invention are such that the financial institution can make a profit due to the difference (i.e., spread) between the interest rate actually earned through management and the interest rate that is offered to the client. In other words, typically, the financial institution makes sure that the difference (i.e., spread) between the interest rate applied to the management of the financial institution's own assets and the interest rate which the financial institution offers to the client can produce a profit. This spread enables the financial institution to obtain profits. Furthermore, the financial institution can obtain profits from exchange service fees, and can obtain profits by means of collecting service fees for cancellation of contracts for financial derivative products before maturation dates and collecting interest on lending (such as in the case when the client is managing the financial derivative product based on borrowed money, for example).

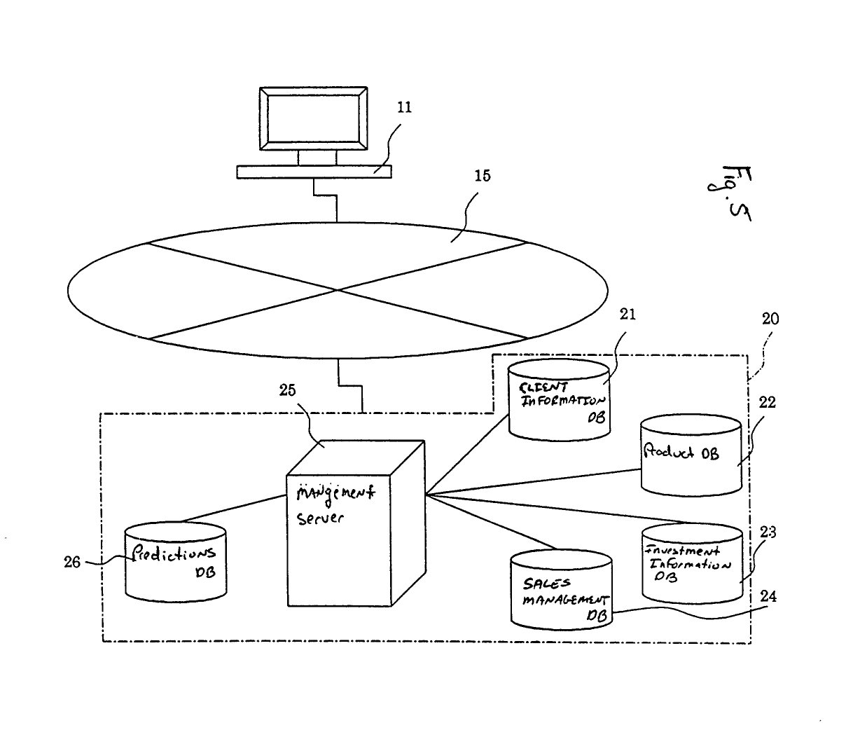

Next, explanation will be made of a First Embodiment of a device for performing sales, for example, of a financial derivative product which uses the above described investing method, making use of FIG. 5 through FIG. 9.

As shown in FIG. 5, a device for investing 20 is arranged on a high speed communications network 15 so as to be accessible from a client terminal device 11 through the high speed communications network 15 by means of the internet, for example.

The device for investing 20 is comprised of a client information database 21; a product database 22; an investment information database 23; a sales management database 24; a prediction database 26; and a management server 25 connected to each of the databases 21, 22, 23, 24 and 26.

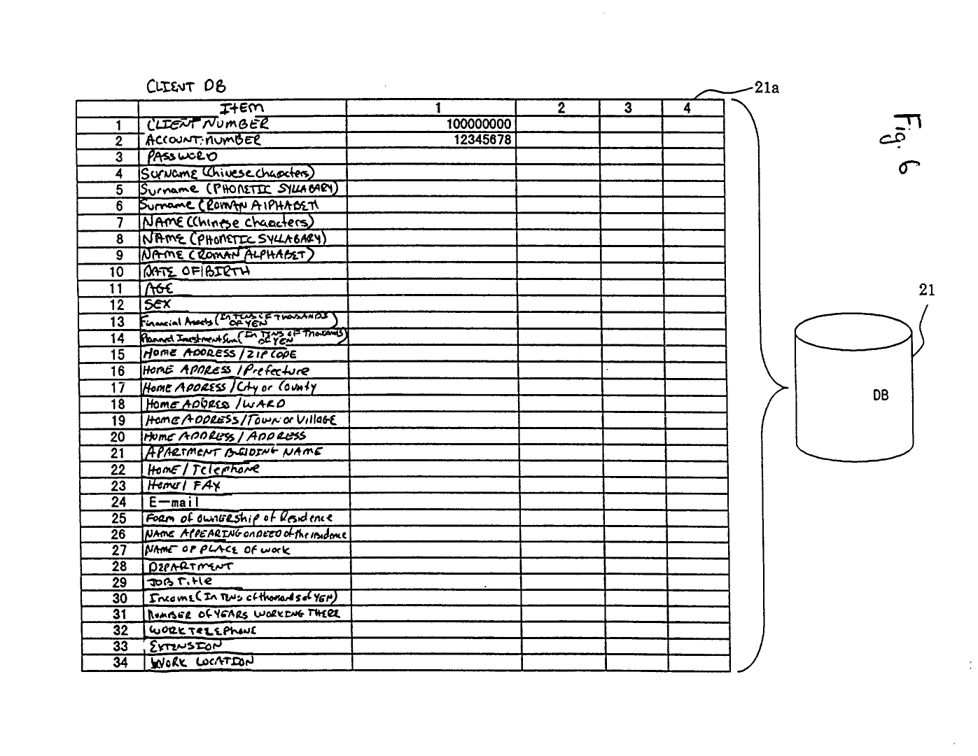

As shown in FIG. 6, the client database 21 is a database for managing for each client all types of personal information pertaining to each client, and has a table 21a in which the personal information of each client is registered and organized. In this table 21a the personal information is registered, which includes a client number, account number, password, surname (in Chinese characters), surname (in phonetic syllabary), surname (in Roman alphabet), name (in Chinese characters), name (in phonetic syllabary), name (in Roman alphabet), date of birth, age, sex, financial assets (in units of JPY 1,000), planned amount of investment (in units of JPY 1,000), zip code of home address, location of home (prefecture, city/county, ward, town/village, address, apartment building name), home telephone, home fax, E-mail, form of ownership of residence, name appearing on deed of the residence, name of place of work, department, job title, yearly income (in units of JPY 1,000), number of years working there, work telephone, extension number, and work location of the clients is registered. Further, this personal information registered in the table 21a is not limited to the information described above.

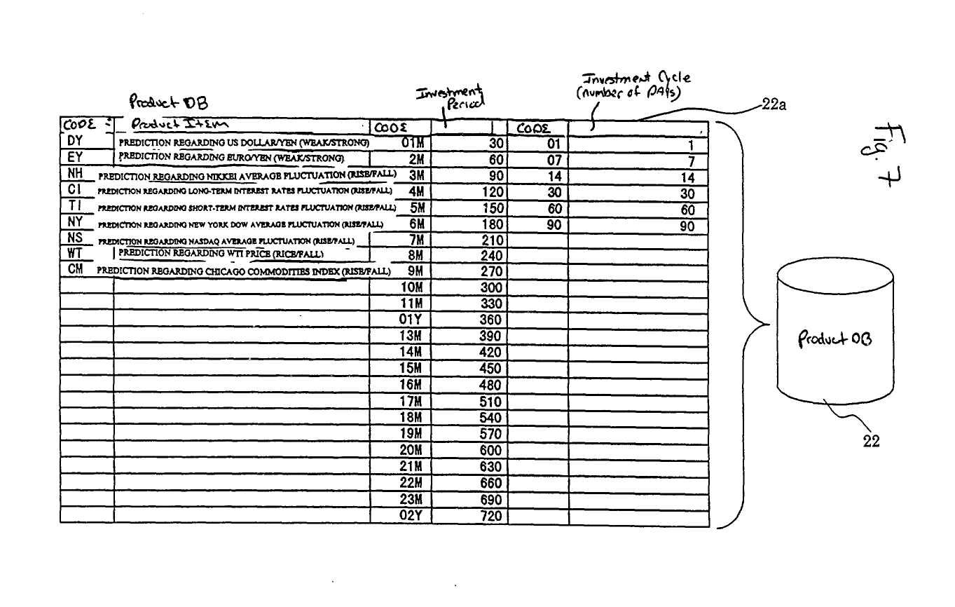

As shown in FIG. 7, the product database 22 is a database for managing a group of products that a financial institution offers to clients (i.e., various types of derivative options in the present example), and comprises a table 22a in which a product item code of a product group to be offered to the client, a product item, an investment period code, an investment period, an investment cycle code and an investment cycle (i.e., number of days) are registered and organized according to each product type. Further, the products stored in this product database 22 are options which are repeatedly purchased using interest 3 applied to an investment principal 2 which is entrusted to the financial institution by the client.

Further, a specific list of the products shown in FIG. 7 can be comprised of a prediction regarding the US Dollar/Yen exchange rate(i.e., whether the Yen will be strong or weak) which is the call/put digital option (cash or nothing option) explained in connection with the examples described above, a prediction regarding the Euro/Yen exchange rate(i.e., strong or weak Yen), a prediction regarding fluctuations in the Nikkei Average (i.e., whether it will rise or fall), a prediction regarding long-term interest rates (i.e., whether they will rise or fall), a prediction regarding short-term interest rates (i.e., whether they will rise or fall); a prediction regarding the NY Dow Average (i.e., whether it will rise or fall), a prediction regarding the NASDAQ Average (i.e., whether it will rise or fall), a prediction regarding the WTI Price (i.e., whether it will rise or fall) and a prediction regarding the Chicago Commodities Index (i.e., whether it will rise or fall).

The investment information database 23 is a reference which is used when the client purchases each of the financial derivative products described above, and is a database for managing the interest rate applied in the interest 3 set on the investment principal 2. That is, as described above, the investment principal 2 can be a variety of things including funds for the purchase of varieties of currencies and stocks, for example; however, the interest rate applied in the interest 3 varies depending on the type of investment principal 2. The investment information database 23 is for managing each of the different types of interest rates applied for the interest 3.

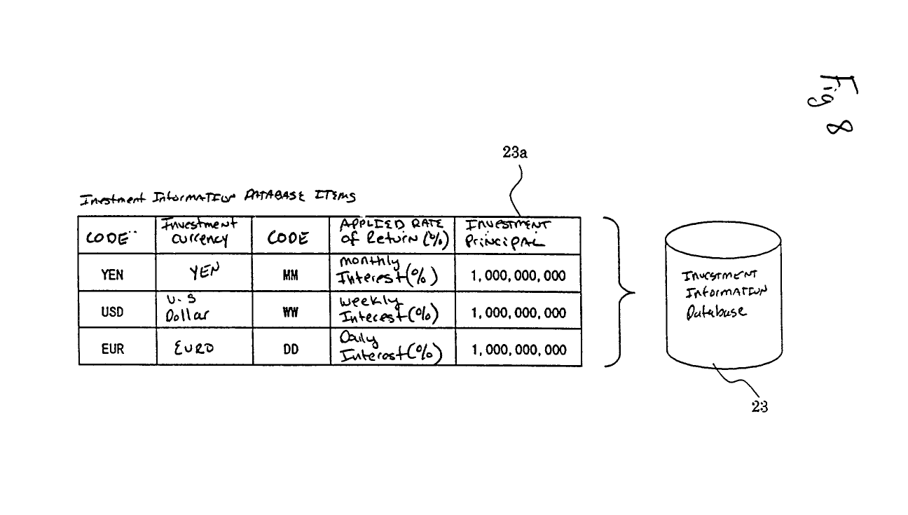

As shown in FIG. 8, in the investment information database 23 has registered therein a code indicating the currency of the investment principal 2; an investment currency; a code for the applied interest rate; the applied interest rate (i.e., a percentage); and the amount of the investment principal 2, and the investment information database 23 comprises a table 23a organized separately for each of the currencies. Note that in the example depicted in FIG. 8 the table 23a registers currency codes, investment currencies, applied interest rate codes, applied interest rates (%) and the sums of the investment principals 2 for each of the currencies of Yen, US Dollar and Euro.

The sales management database 24 is a database which registers a variety of types of data according to client, such as client name, product types sold and purchase dates, for example.

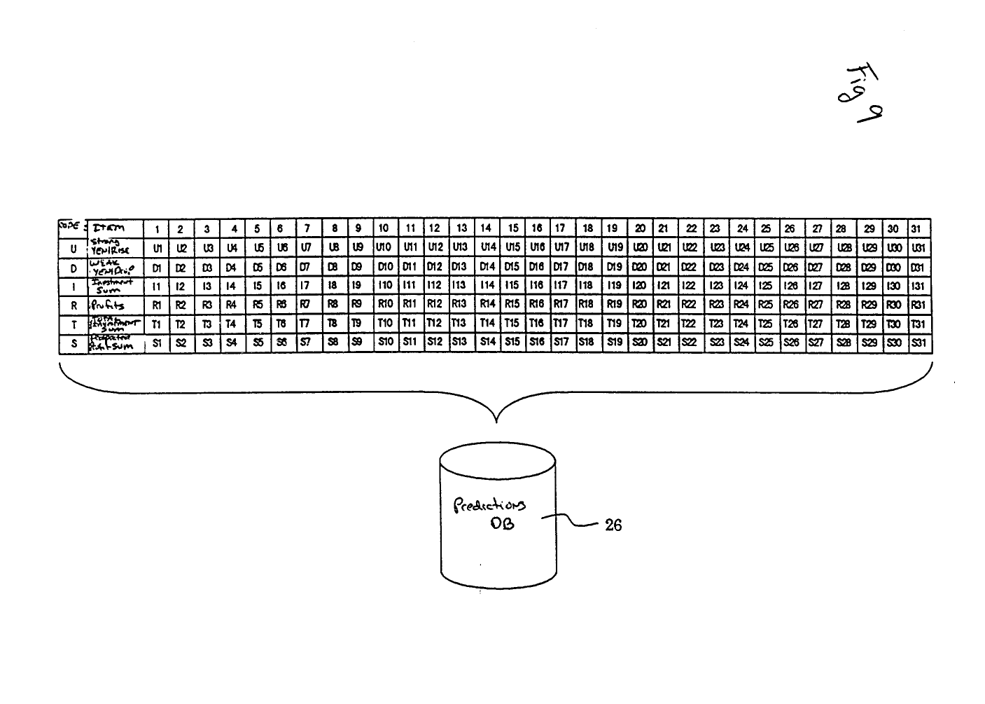

Further, the prediction database 26, as shown in FIG. 9, is a database for registering profit predictions in the cases when the client purchases the financial derivative product 1 described above and determines purchases of options (i.e., determines predictions) for each of the predetermined dates. Specifically, in the sales management database 24 there are item codes fixed to each of the items which include the client's prediction (i.e., regarding a strong Yen or a rise in an index or price); the client's prediction (i.e., regarding a weak Yen or a drop in an index or price); the amount of the investment (i.e., the costs involved in each of the option purchases, namely the funds for investing 5); profits; total invested sum (which is a total sum of investments including the investment principal 2); and a sum of expected profits, and together with these item codes being fixed to each item the prediction database 26 also has each of these codes fixed separately to each of option purchases.

The management server 25 is connected to each of the databases 21, 22, 23, 24 and 26 described above, and additionally, is accessible from the client terminal device 11 via the high speed communications network. Then, when the client inputs a product type which the client wishes to purchase, for example, the management server 25 sends information to the client terminal device 11 based on the inputted information.

As an example, in the case when the client wishes to know the group of products purchased in each option, the management server 25 extracts data from the product database 22 regarding each of the types of products and sends to the client terminal device 11 information in which this data has been organized. Further, as another example, in the case when the client wishes to know the interest rate to be applied for each currency, the management server 25 extracts data from the investment information database 23 regarding applied interest rates for each variety of currency, and sends to the client terminal device 11 information which has organized this data. Further, in the case when the client wishes to know the profits, for example, which can be obtained in the case when a financial derivative product offered by the financial institution is actually purchased and the rights thereto are exercised, the management server 25 extracts data from the prediction database 24 regarding profits, for example, and sends to the client terminal device 11 information which has organized this data.

Further, the management server 25 not only extracts information (data) desired by the client from each of the databases 22, 23 and 24, but can also perform online purchases of and online cancellation before maturation of contract for the financial derivative products offered by the financial institution. That is to say that the management server 25 is capable of inputting personal information and transaction condition necessary for the purchase of the financial derivative product 1, and purchasing the financial derivative product 1 or performing premature cancellation of a contact. Accordingly, the management server 25 is a device capable of inputting and outputting transaction information with the client.

Further, since the device for investing 20 is constructed as described above, it is also possible to connect to the management server 25 a database or a communications device which is connected to a listed options market and an OTC options market and is capable of obtaining market data.

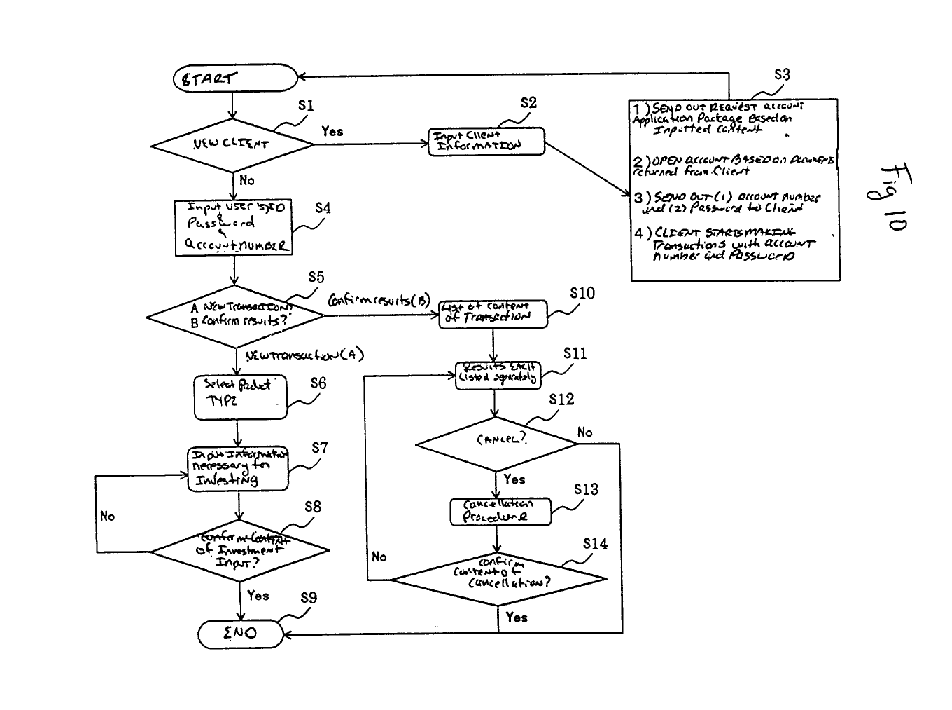

Next, explanation will be made of an investing system which uses the device for investing 20 for performing sales of and other operations relating to financial derivative products which use the investing method described above. More specifically, explanation will be made, using FIG. 10, of actions made by a client and by a financial institution up until a point when the client connects to the management server 25 and purchases the financial derivative product or cancels a contract before its completion.

As described above, it is possible for the client to access the management server 25 via the high speed communications network 15. A new client (which falls under “Yes” in step S1) inputs personal information (step S2) that is necessary for opening an account (for example address, name, telephone number, etc.).

Based on the inputted information, the financial institution sends to the client an application package for opening the account, opens the account based on the response documents from the client, and also, sends an account number and password to the client. As a result, the client is now able to begin transactions with the financial institution which handles the financial derivative product 1 (step S3). In other words, when the procedure passes through Start and returns to step 1 the client will already have an account at that time, and will not be a new client.

Now, the client who is not new and does have an account (i.e., falls under “No” in step S1) inputs a user ID and the password given to the client by the financial institution and the account number of the account opened by the financial institution (step 4).

At step S4, when a client has inputted the necessary information and makes a new request for a new financial derivative product as offered by the financial institution (i.e., when the procedure advances to A in step S5), the client selects a product type which the client wishes to purchase (step S6). Then, after performing this selection, the client inputs various information necessary for making the investment with that selected product type (step S7). Further, the “selection” mentioned here indicates the selection of the various terms described above, such as the selection of the monetary sum of the investment principal, the selection of the option type to be purchased, the investment period and the investment cycle, for example. Then the inputs at step S7 are finished, and if the inputted content is correct (i.e., “Yes” in step S8) then the inputs are fixed and the purchase request for the financial derivative product is completed (step S9). Note, however, if there was an input error at step S7 (which falls under “No” in step 8), then the process returns to step 7, the inputs are redone, and the process advances to step 8 and then step 9.

At step S4, when the client has inputted the necessary information, the client has already purchased a financial derivative product offered by that financial institution and confirmation of the results of the financial derivative product which has already been purchased is performed (i.e., when the process advances to B in step S5), then a list of content of transactions regarding the purchased financial derivative product(s) is sent from the device for investing 20 to the client terminal device 11 (step S10).

Then the client confirms the contents and results of the transactions (step S11). In the case when the client confirms transaction contents and then cancels the contract (i.e., the case which falls under “Yes” in step S12), contract cancellation procedures are carried out (step S13) and, when the content of the cancellation request is confirmed (which is “Yes” in step S14), the cancellation request is fixed and the request for the cancellation of the financial derivative product(s) is completed (step S9). Additionally, in the case when the contract is not cancelled after the confirmation of the results at step S11 (i.e., “No” in step S12), the procedure is also ended here (step S9). The ending of the procedure means the termination of the contract cancellation procedure. Note that in the case when the cancellation content is not confirmed at step S14 the process returns to step S11, the confirmation of the results is performed again, and the process advances to step S12, step S13, step S14 and step S9.

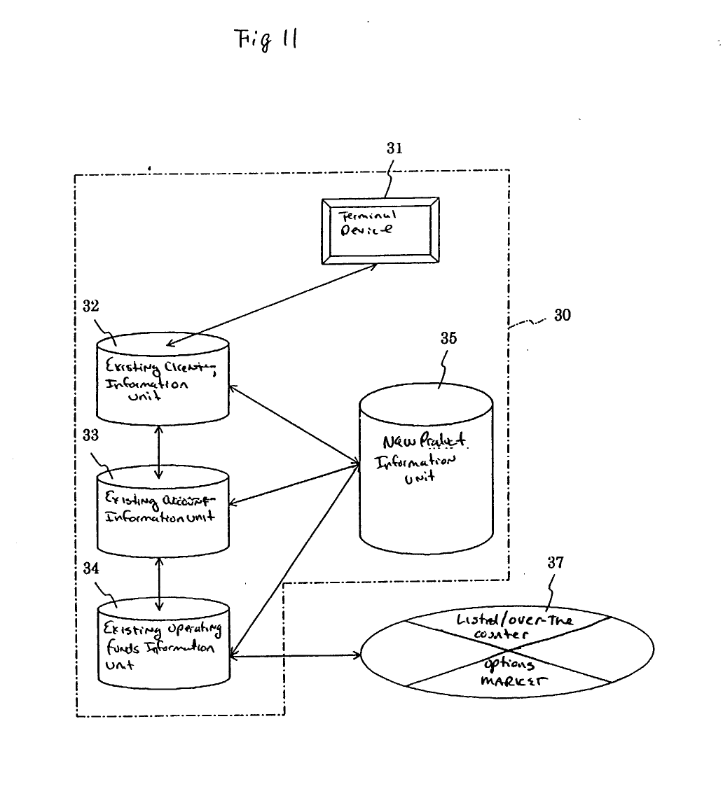

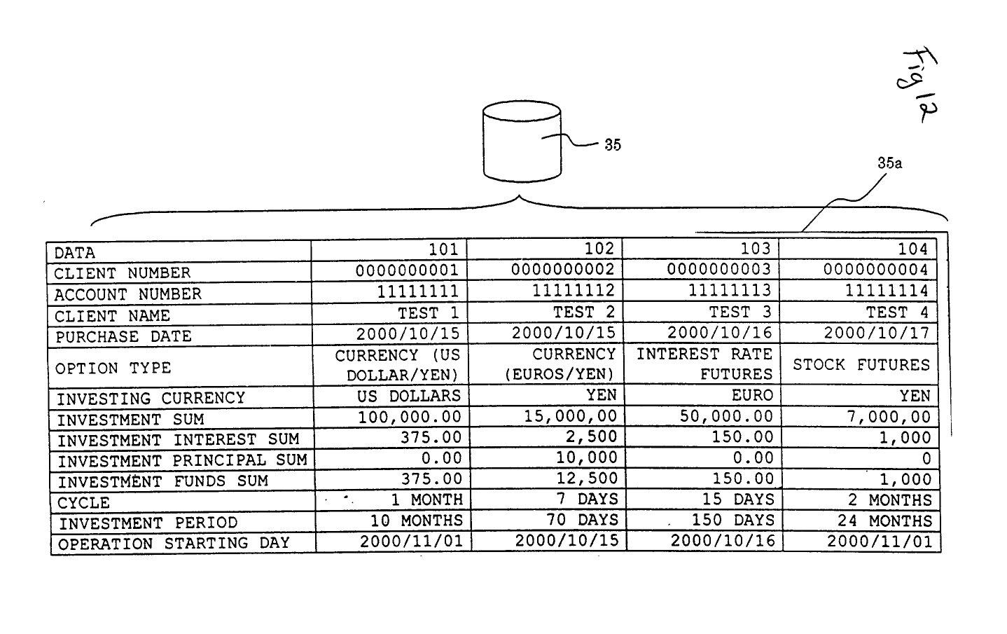

Next, explanation will now be made using FIG. 11 and FIG. 12, of a second Embodiment of the device for investing which is for performing sales of the financial derivative product or the like that uses the investing method described above.

As depicted in FIG. 11, a device for investing 30 is comprised of a financial institution terminal device 31 capable of inputting and outputting personal information regarding the client and transaction information; an existing client information unit 32 capable of mutually exchanging information with the financial institution terminal device 31; an existing account information unit 33 capable of mutually exchanging information with the existing client information unit 32; an existing operating funds information unit 34 capable of mutually exchanging information with the existing account information unit 33; and a new product information unit 35 capable of mutually exchanging information with the existing client information unit 32, with the existing account information unit 33 and with the existing managed funds information unit 34.

The existing client information unit 32 is a device corresponding to the client information database 21 of the device for investing 30 described above, and is comprised of a database for managing each kind of personal information pertaining to each client with whom there already exists a business relationship (including cases when the client has simply opened a normal account, for example). The existing account information unit 33 is comprised of a database for managing the account of each client with whom there already exists a business relationship (i.e., for example, managing the balances, etc.). The existing operating funds information unit 34 is for managing data relating to money management already undertaken by the financial institution. Further, the existing funds management information unit 34 is connected to the listed and OTC options markets 37 and can perform the funds management (meaning, specifically, making use of the funds on the market, for example) while obtaining information from each of the markets 37.

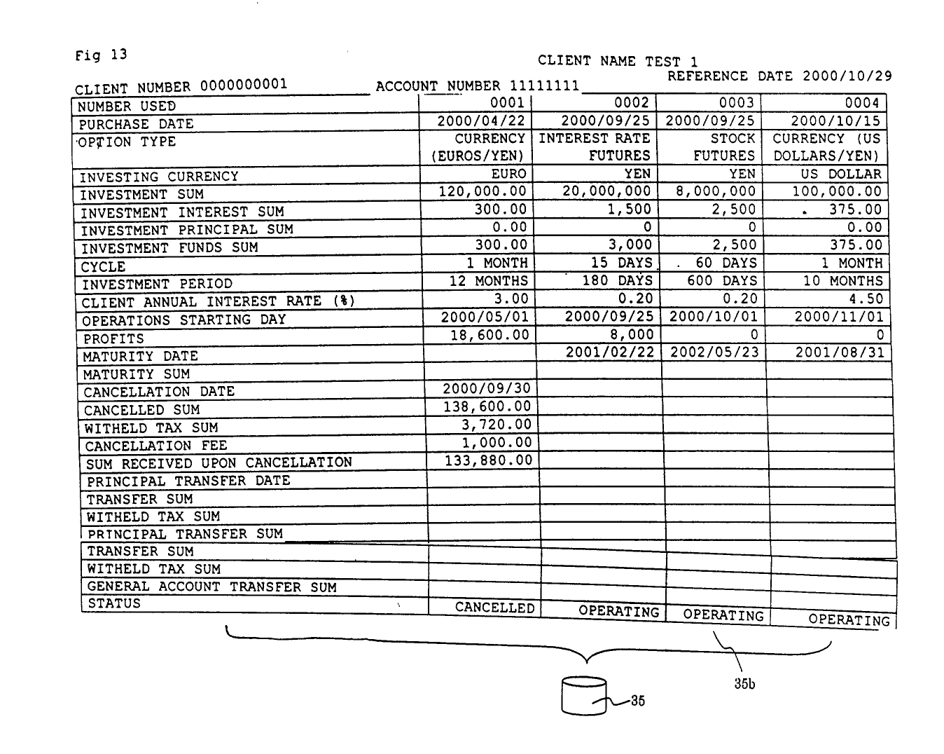

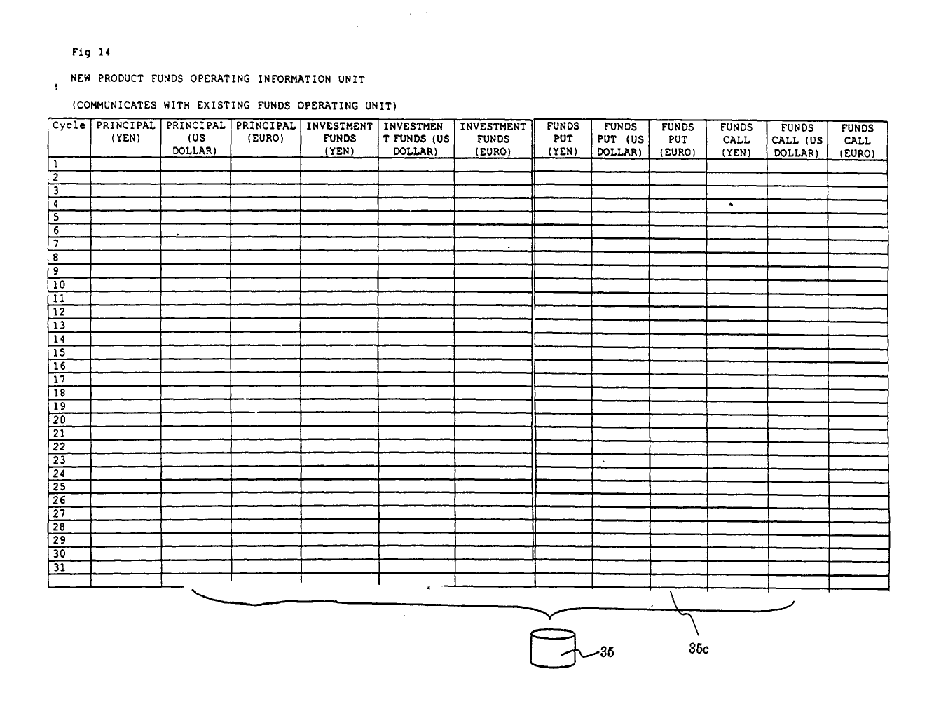

Explanation will now be made of a construction of the new product information unit 35, making use of FIG. 12, FIG. 13 and FIG. 14.

As shown in FIG. 12, the new product information unit 35 is provided with a database of purchased products 35a for recording the content of the financial derivative product type 1 purchased by each of the clients.

The items recorded in this database of purchased products 35a are data (with a management number); the client number; the account number; the client name; a date of purchase (of the financial derivative product); a (selected) option type; the investment currency (in which the financial institution received the investment principal); the monetary sum of the investment (i.e., the sum of the investment principal); the sum of the investment interest (i.e., the monetary sum of the interest to be used as funds for investing); the sum of the investment principal (i.e., the sum of the investment principal to be used as funds for investing); the sum of the funds for investing; the cycle (of the option purchases); the investment period; and a management start date. These items are each organized according to client and registered in the database of purchased products 35a. Each time a client's new transaction information is inputted to the financial institution terminal device 31 and this information is sent to the existing client information unit 32, the database of purchased products 35a is rewritten with the most recent of this information.

As shown in FIG. 13, the new product information unit 35 is equipped with a respective client product management database 35b which has recorded the management status of the purchased financial derivative product 1 for each client separately.

The items registered in the respective client product management database 35b are a usage number; a date of purchase (of the financial derivative product); a (selected) option type; the investment currency (in which the financial institution received the investment principal); the monetary sum of the investment (i.e., the amount of the investment principal); the sum of the investment interest (i.e., the sum of the interest to be used as the funds for investing); the sum of the investment principal (i.e., the monetary amount of the investment principal to be used as the funds for investing); the sum of the funds for investing; the cycle (of the option purchases) the investment period; the client's annual interest rate (as a percentage); the management start date; profits; the maturation date; the maturation amount; a premature contract cancellation date; the sum in the case of premature contract cancellation; a sum of withheld taxes; a processing charge for premature contract cancellation; a sum received in the case of such cancellation; a date of transfer of the principal; the sum transferred; a sum of withheld taxes; the sum of the principal transferred; a date of the transfer to a general account; the sum transferred; a sum of withheld taxes; a sum of the amount transferred to the general account; and the status. Further, the respective client product management database 35b has a table in which the data of each of the items described above is recorded for each of the clients. In the case when one client has purchased a plurality of the financial derivative products this table lumps together the information pertinent thereto and records this information in an organized state. Each time a client's new transaction information is inputted to the financial institution terminal device 31 and this information is sent to the existing client information unit 32, the respective client product management database 35b is rewritten with the newest of this information.

As shown in FIG. 14, the new product information unit 35 is equipped with a funds management database 35c for making good on the costs of option purchases amassed through the clients' purchases of the financial derivative products 1, or, in other words, for fulfilling the financial institution's obligation (of payment) to the clients as part of the financial derivative products 1.

The items registered in this funds management database 35c are the investment cycle; the principal (in Yen); the principal (in US Dollars); the principal (in Euros); the funds for investing (in Yen); the funds for investing (in US Dollars); the funds for investing (in Euros); the funds put (in Yen); the funds put (in US Dollars); the funds put (in Euros); the funds call (in Yen); the funds call (in US Dollars); and the funds call (in Euros) For each of these items the investment sum invested by the client is recorded in the funds management database 35c. Each time that the client's new transaction information is inputted into the financial institution terminal device 31 and this information is sent to the existing client information unit 32, the funds management database 35c is rewritten with the newest of this information. The existing managed funds information unit 34 described above selects a high yield option market and invests the pooled capital based on the data recorded in the funds management database 35c.

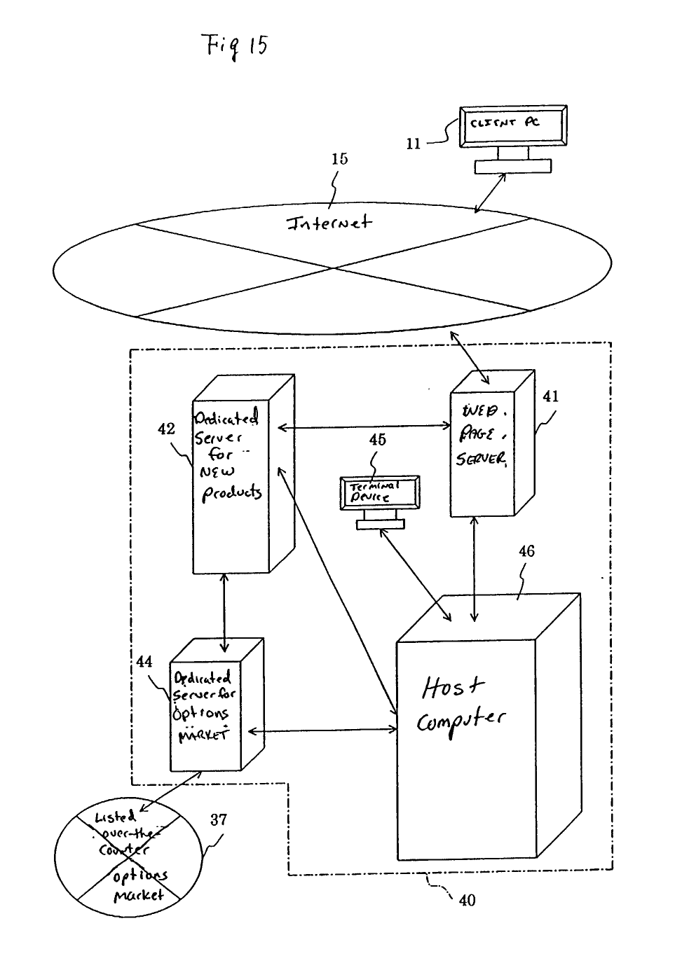

Next, explanation will be made using FIG. 15 of a Third Embodiment of the device for investing for performing sales of the financial derivative product or the like that uses the investing method described above.

As shown in FIG. 15, the device for investing 40 comprises a web page server 41 arranged on the high speed communications network 15 so as to be accessible from the client terminal device 11 via the high speed communications network being comprised of the internet, for example; a dedicated server for new products 42 capable of performing exchange, inputting and outputting of information with the web page server 41; a dedicated option market server 44 capable of performing exchange of information with the dedicated server for new products 42, and also capable of inputting and outputting information; a financial institution terminal device 45 installed at a store front of the financial institution, for example; and a host computer 46.

This device for investing 40 enables the client to use the internet to purchase the financial derivative product 1 described above. That is, the client uses the internet to input necessary personal information and information necessary for the purchase of the financial derivative product 1 through the web page that handles the financial derivative product 1 on the web page server 41. Then, the host computer 46 certifies the client based on the inputted personal information from the client, and if the results of this certification are normal then the sale of the requested financial derivative product 1 is established. Based on this processing, new information regarding this client who has purchased the financial derivative product 1 is inputted to the dedicated server for new products 42. Then the dedicated option market server 44 performs the necessary investment in the market based on this new information, obtaining information from the listed and OTC options markets 37 as needed.

Note that it is possible for the device for investing 40 enables over-the-counter sales of the financial derivative product 1. In other words, it is possible to perform the purchase request for the financial derivative product 1 over the counter of a financial institution, without using the internet. In this case, the input of the necessary information is conducted through the financial institution terminal device 45, which is installed at the store front of the financial institution, for example.

In the web page server 41 there is stored a web page which the client can use by utilizing the internet, to perform the purchase of the financial derivative product 1 offered by the financial institution described above. Note that detailed description of the web page serving as the sales window for this financial derivative product 1 will be made below.

The dedicated server for new products 42 either has databases which are equivalent to each kind of the databases relevant to the financial derivative product 1, which is to say databases equivalent to each of the databases 21, 22, 23, 24 and 26 connected to the management server 25 of the device for investing 20 described above, or it has databases which are equivalent to each of the databases 35a, 35b and 35c stored in the new product information unit 35 of the device for investing 30 described above.

The dedicated option market server 44 is connected to the listed and OTC options markets 37 via the communications network, and is configured so as also to be able to perform the management of the capital (which means, specifically, making use of the capital on the markets, for example) while obtaining information from each of the markets 37. In other words, the dedicated option market server 44 is a server having functions equivalent to the existing operating funds information unit 34 of the device for investing 30 described above.

Further, the financial institution terminal device 45 is a device installed at the store front of the financial institution, for example, and is a device for a store staff person of the financial institution or for the client him/herself to input and output such information as the client's personal information and transaction information at the time of the client's purchase of the financial derivative product 1 and other types of products at the store front of the financial institution. In other words, the financial institution terminal device 45 indicates the ATMs which are conventionally installed inside financial institutions and terminal devices conventionally used by the financial institution staff people.

The host computer 46 is a device capable of inputting and outputting all information managed by the financial institution, and is provided with the various databases, control devices and other equipment used to realize such a device. More specifically, the host ‘computer 46 is equipped with a database for managing the client's personal information and transaction information, a database for managing the financial institution's own assets, and a database for managing the lender-lendee relationships which develop between the financial institution and other financial institutions, business enterprises, etc.

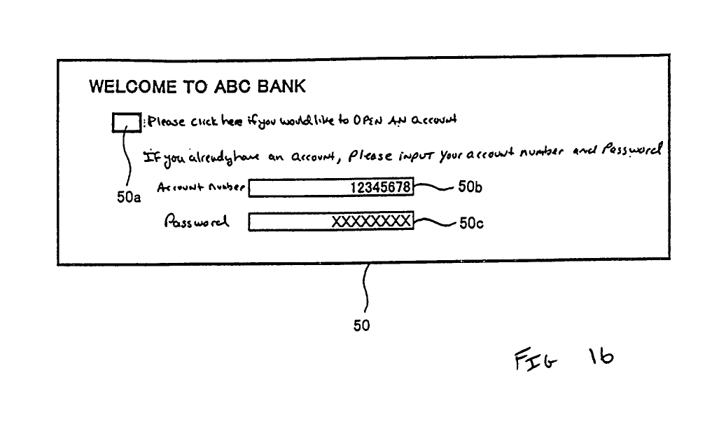

Next, explanation will be made of a procedure by which the client connects to the web page server 41 of the device for investing 40 and performs the purchase request for the financial derivative product 1 from the web page, making use of FIGS. 16-24 which depict screens of the web page.

The client uses the client terminal device 11 to connect through the internet to the web page server 41 of the device for investing 40. Then the client inputs a predetermined address, downloads a web page 50 such as the one shown in FIG. 16 and displays the web page 50 on the monitor of the client terminal device 11. This web page 50 serves as a window of the financial institution engaged in the sale of the financial derivative product 1 described above.

A new client who does not have an account with the given financial institution clicks on an access button 50a linking to a web page for opening accounts which is in the web page 50, and then the new client makes predetermined inputs, for example, on this web page for opening accounts and thus opens an account. Then the client accesses this web page 50 once again and makes predetermined inputs into an account number input column 50b and a password input column 50c. Note that a client who already has an account number can start from the operation of inputting of the account number and the password.

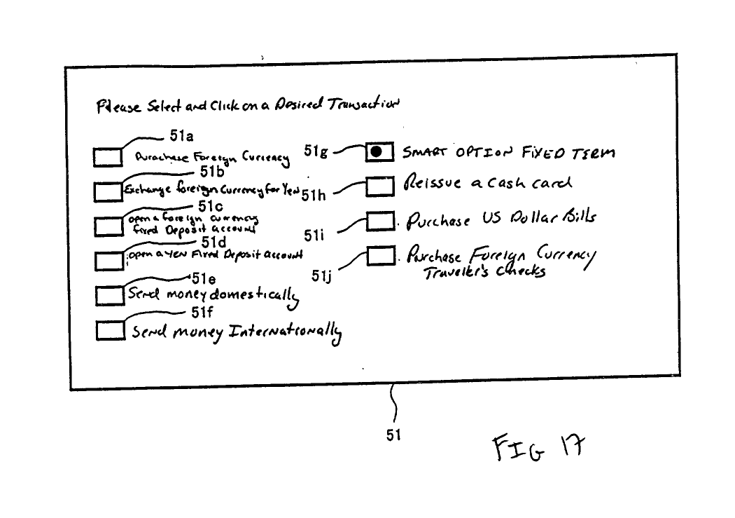

When the input of the account number and the password has been performed, a transaction request page 51 appears as shown in FIG. 17. On this transaction request page 51 there is a foreign currency request purchase access button 51a; a foreign currency-to-Yen currency exchange request access button 51b; an access button for making a request to open a foreign currency fixed term deposit 51c; an access button for making a request to open a Yen fixed term deposit 51d; a domestic remittance request access button 51e; an international remittance request access button 51f; an access button for making a request for the financial derivative product 1 described above (the appellation “smart option fixed deposit” is used here) 51g; an access button for requesting reissuing of a cash card 51h; a US Dollar bill purchase request access button 51i; and a foreign currency travelers checks purchase request access button 51j. The client selects the smart option fixed deposit request access button 51g from among the access buttons mentioned above and clicks on it.

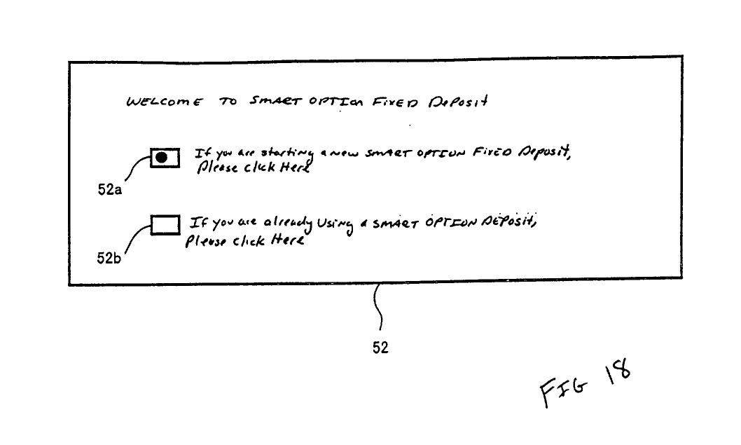

As a result of these actions, a financial derivative product transaction request page 52 appears, as shown in FIG. 18, with which it is possible to perform the purchase of the financial derivative product (i.e., the smart option fixed deposit) 1, the cancellation of a contract, a confirmation of management performance or other such operation. In the case when the client wishes to make a request for the purchase of a financial derivative product 1 for the first time, the client clicks on a new request button 52a on this page 52. On the other hand, in the case when a purchase has already been made and either the client wishes to know the asset management status of the financial derivative product 1 which the client has already purchased or the client wishes to make a request for cancellation of the contract before maturity, the client clicks on an access button for clients currently engaged in utilization 52b.

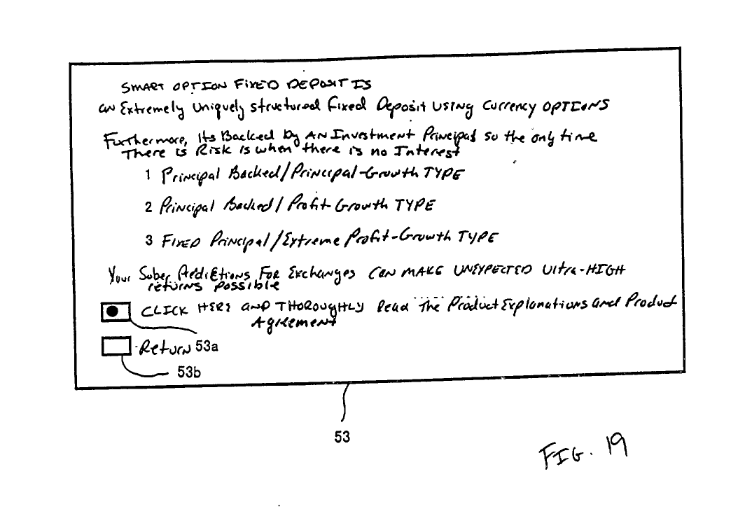

When the client clicks on the new request access button 52a a product introduction page 53 appears for introducing the financial derivative product (smart option fixed deposit) 1 product types, as shown in FIG. 19. On this product introduction page 53 there is an introduction which explains that the financial derivative product (smart option fixed deposit) 1 is “a fixed term deposit structured using currency options” and that “the investment principal is guaranteed”, and explains that there are 3 types.

The first product type is a “Principal Guaranteed/Principal Growth Type”. This type guarantees the entire sum of the investment principal 2, and also uses profits to grow this investment principal (i.e., the investment principal increases in amount). This type is the tenth product type shown in FIGS. 4A to 4F described above.

The second product type is a “Principal Guaranteed/Profits Growth Type”. This type guarantees the entire sum of the investment principal, and also incorporates profits into the funds for investing 5 for the next purchase so as to grow the funds for investing 5 to a larger amount than those of the previous time, in order to grow (increase the amount of) the profits obtained the next time so as to be greater than the previous time. This is the seventh product type shown in FIG. 3 described above.

The third product type is a “Fixed Principal/Ultra-Profits Growth Type”. Note that the third product type uses a part of the investment principal 2 as funds for investing 5 for investing in the options and the entire sum of the investment principal 2 is not guaranteed; however, 90% for example, or some other fixed amount thereof can be fixed and guaranteed. Further, the content of each of the product types is omitted here since detailed explanations are made above in the explanations of the product types.

As shown in FIG. 19, the product introduction page 53 has a product content explanation page access button 53a for opening a product content explanation page 54 containing an explanation of the financial derivative product (smart option fixed deposit) 1 and the product agreement; and a return button 53b for returning to the web page 50.

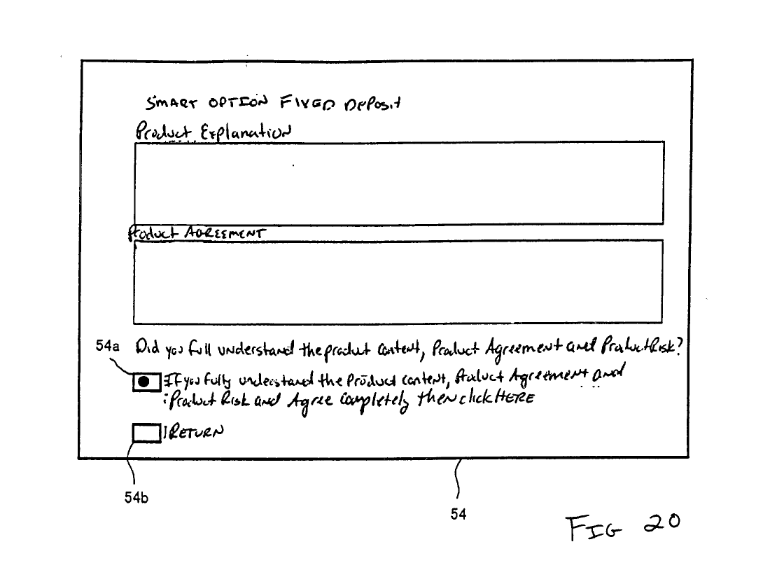

Then, when the client clicks on the product content explanation page access button 53a, the product content explanation page 54 opens up as shown in FIG. 20. This product content explanation page 54 contains a product explanation of the financial derivative product (smart option fixed term deposit) 1, the product agreement, and the relevant risk and other aspects of the financial derivative product smart option fixed term deposit) 1. Further, for the client who has understood and agrees with the product explanation and the product agreement, the product content explanation page 54 has a selection page access button 54a for opening up a selection page 55 for selecting a prediction type and a product type and a return button 54b for returning to the web page 50.

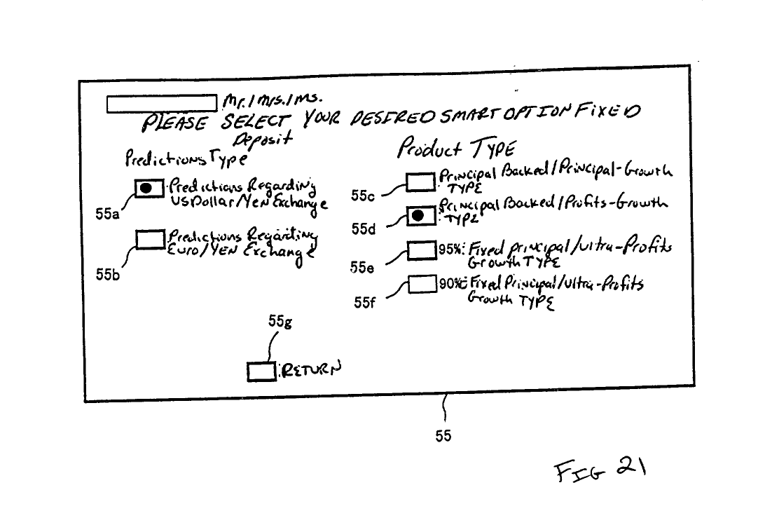

Then, when the client clicks on the selection page access button 54a, a selection page 55 appears as shown in FIG. 21. This selection page 55 is provided with selection buttons 55a, 55b for selecting the client's prediction item. The prediction item indicates which product type is to be purchased from the options described in the explanations above of the examples of the financial derivative product 1. That is, the client clicks on the selection button 55a in the case when the client wishes to select a purchase of a call/put option which predicts whether the Yen will be stronger or weaker against the Dollar on a predetermined date as compared to a reference date. On the other hand, the select button 55b is to be clicked on in the case when the client wishes to purchase a call/put option which predicts whether the Yen will be stronger or weaker against the Euro on a predetermined date as compared to a reference date.

Further, on the selection page 55 there are selection buttons 55c, 55d, 55e and 55F for selecting a product type. The product types are differentiated by what is appropriated for use as the funds for investing 5, as addressed in the explanations of each of the examples of the financial derivative product 1 above.

In other words, the selection button 55c, on which “Principal Guaranteed-Principal Growth Type” is written, is a button for the product type in which only the interest 3 is appropriated for use as funds for investing 5, and when profits are obtained from investment of these funds for investing 5 these profits are incorporated into the investment principal 2. That is, the selection button 55c is a button which the client clicks on to select the tenth product type which was explained using FIGS. 4A to 4F.

Further, the selection button 55d, on which “Principal Guaranteed-Profits Growth Type” is written, is a button for the product type in which only the interest 3 is appropriated for use as the funds for investing 5, and when profits are obtained from investment of these funds for investing 5 a combination of the entire sum of these profits plus the interest 3 is used as the funds for investing 5 for the subsequent option purchase. That is, the selection button 55d is a button which the client clicks on to select the seventh product type which was explained using FIG. 3.

Further, the selection button 55e, on which “95% of Principal Guaranteed-Ultra-Profits Growth Type” is written, is a button for the product type in which a part or all of the interest 3 plus 5% of the investment principal 2 is appropriated for use as the funds for investing 5 (i.e., the remaining 95% of the investment principal 2 is not used for the funds for investing and is guaranteed). That is, the selection button 55e is a button which the client clicks on to select the fifth and sixth product types which were explained using FIG. 2 (E) and (F). Additionally, the selection button 55f, on which “90% of Principal Guaranteed-Ultra-Profits Growth Type” is written, is a button for the product type in which a part or all of the interest 3 plus 10% of the investment principal 2 is appropriated for use as the funds for investing 5 (i.e., the remaining 90% of the investment principal 2 is not used for the funds for investing and is guaranteed). That is, the selection button 55f is a button which the client clicks on to select the fifth and sixth product types which were explained using FIGS. 2E and 2F.

Note that on the selection page 55, too, there is a return button 55g for returning to the web page 50 just as on the pages 53 and 54 described above.

When the client selects the selection button 55a (for prediction of the US Dollar/Yen exchange rate) and the selection button 55d (“Principal Guaranteed-Ultra-Profits Growth”) which are provided on the selection page 55, an investment content configuration page 56 appears which is for the situation when the “Principal Guaranteed-Ultra-Profits Growth” product type is selected. This investment content configuration page 56 is also a page for setting the type of currency to be used as for the investment principal 2, the amount of the investment principal 2, and the detailed content of the funds for investing. Note that in the present example the investment period (12 months) and the investment cycle (1 month) have been fixed and are not selectable; however, it is also possible to have these be selectable from among a number of setting types.

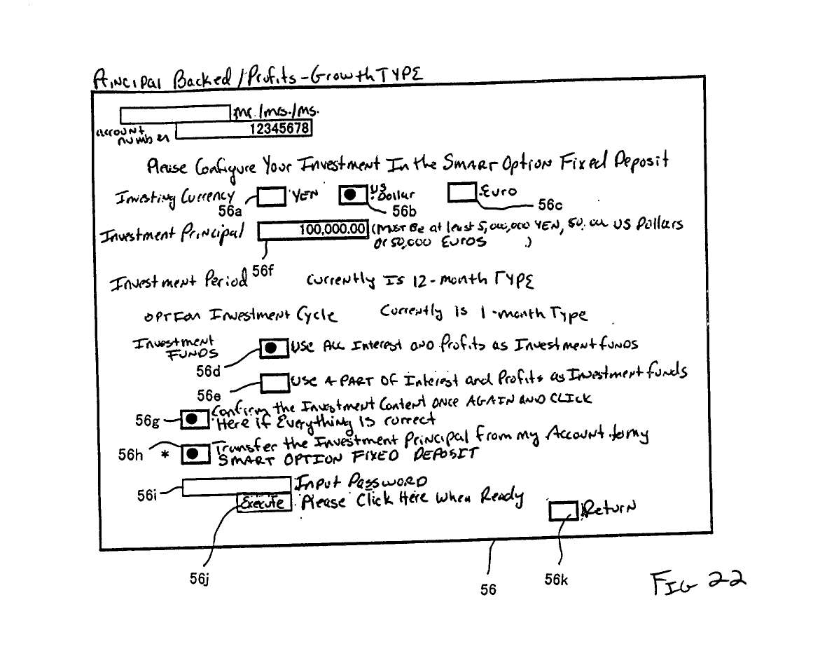

As shown in FIG. 22, the investment content configuration page 56 includes selection check columns 56a, 56b, 56c, 56d and 56e. The selection check columns 56a (Yen), 56b (US Dollars) and 56c (Euros) are columns for the selection of the currency of the investment principal 2. Further, the selection check columns 56d, 56e are for performing detailed configuration of the funds for investing 5, so 56d is a column to be checked in order to use the entirety of the interest and the profits for the funds for investing, and 56e is a column to be checked in order to use a part of the interest with the profits as the funds for investing.

Further, as shown in FIG. 22, on the investment content configuration page 56 there is an investment principal amount input column 56f for setting the amount of the investment principal 2. Additionally, on the investment content configuration page 56 there is a confirmation check column 56g for providing confirmation that the checks made in the selection check columns 56a, 56b, 56c, 56d and 56e are correct, and that the sum inputted in the investment principal amount input column 56f is correct in the case when these are correct. Furthermore, the investment content configuration page 56 is provided with a confirmation check column 56h for having the client confirm a transfer of the inserted investment principal amount from the client's account to the smart option fixed term deposit; a password input column 56i; an execute click button 56j for the client to click on in order to execute; and a return button 56k in order to return to the web page 50.

When the client selects the selection check columns 56b (US Dollars) and 56d (for use of the entire interest and profits as funds for investing) on the investment content configuration page 56, then inputs an amount of 100,000 into the investment principal amount input column 56f and then clicks on the execution click button 56j after going through such operations as making the check marks and inputting the password, for example, then a client predictions input page 57 appears at a predetermined position, in which the content of the settings is fully reflected. Further, in the case when the amount inputted into the investment principal amount input column 56f is greater than the amount deposited in the client's account, a warning such as “Your account has insufficient funds” is displayed on the monitor of the client terminal device 11, the client predictions input page 57 does not open up and the present input action becomes an error.

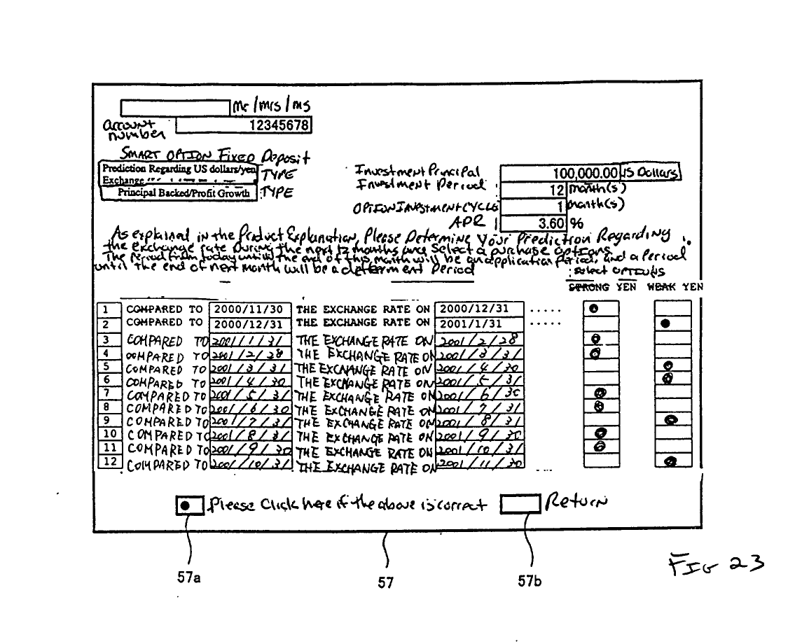

As shown in FIG. 23, the product content which the client has selected is shown on the client predictions input page 57. That is, client predictions input page 57 displays the following: US Dollar/Yen exchange rate prediction type; principal guaranteed-profits growth type; investment principal of US $100,000; 12 month investment period; option investment cycle of 1 month; and annual interest rate of 3.60% as set by the financial institution on the investment principal of US $100,000.

On the client predictions input page 57 the client determines predictions of a strong or weak Yen on the 12 predetermined dates during the investment period (of 12 months). In other words, the client selects options to purchase for each of the predetermined dates. Note, however, that in the present example the first option purchase date is Dec. 31, 2000 and the reference point based on which this purchase date is set is Nov. 30, 2000. This is to say that the client is either predicting that the Yen exchange rate will be higher (strong Yen) or that it will be lower (weak Yen) on Dec. 31, 2000 as compared to the Yen exchange rate against the US Dollar on Nov. 30, 2000.

Further, according to the present example the second option purchase date is Jan. 31, 2001 and the reference point based on which this purchase date is set is Dec. 31, 2000 which was the first option purchase date. That is, the present example is a system in which an option purchase date becomes the reference date for the subsequent purchase. In the present example, this system is adopted for the third purchase and thereafter.

As shown in FIG. 23, after the client performs inputs to make the sequence of the predictions from the first time through the twelfth time (the last time) be strong Yen, weak Yen, strong Yen, strong Yen, weak Yen, weak Yen, strong Yen, strong Yen, weak Yen, strong Yen, strong Yen, weak Yen, and then after the client clicks on a confirmation button 57a on which there appears instructions saying, “If the inputs are correct, please click here” and then a final confirmation page 58 opens up.

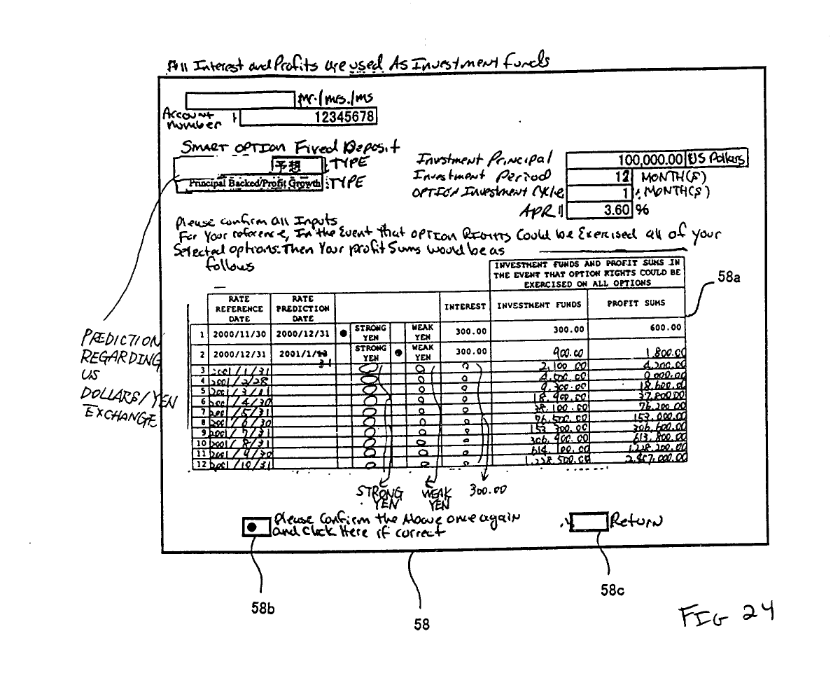

As shown in the upper portion of FIG. 24, the final confirmation page 58 shows the product content selected by the client, like the client predictions input page 57. Additionally, as shown in the lower portion of FIG. 24, the final confirmation page 58 shows an option rights exercise chart 58a with each of the following items: a rate reference date, a rate prediction date (i.e., the option purchase date), the selected option (i.e., the client's prediction), the sum of the interest, the funds for investing and the profits. Note that the figures written in the interest columns are all 300.00 (US Dollars). Actually, the rate prediction dates are all set for the last day of each month, so the number of days between prediction dates actually varies slightly and the sums of the interest should also vary; however, in this chart the sums of the interest are all displayed the same as 300.00 (US Dollars).

Further, the sums of interest appearing in the option rights exercise chart 58a are the sums of interest for the periods of time which are the investment cycles (i.e., 1 month). In the present example this indicate the monetary sums of the interest applied as monthly interest.

Further, the funds for investing appearing in the option rights exercise chart 58a are the amounts of money appropriated for each of the costs of the option purchases on the rate prediction dates (i.e., option purchase dates). The funds for investing in the present example are equal to the sum of the interest plus the profits from the previous investment. Further, The profit sums appearing in the option rights exercise chart 58a are the monetary sums of the profits which the client can obtain in the case when the client's predictions for each of the rate prediction dates (option purchase dates) is accurate and the option rights can be exercised. Note that this option rights exercise chart 58a shows the monetary sum of the profits in the case when the client's predictions for all of the rate prediction dates (option purchase dates) are accurate and all of the option rights can be exercised.

Additionally, the lower portion of the option rights exercise chart 58a shown in FIG. 24 has a decision button 58b for deciding to purchase the financial derivative product (the smart option fixed term deposit) 1 based on the terms appearing in the option rights exercise chart 58a in the case when the client has checked the content appearing in the option rights exercise chart 58a and this content is correct. When the client clicks on this decision button 58b the purchase request actions for the financial derivative product 1 are completed. That is, a sales contract is established between the financial institution and the client for the financial derivative product 1. Note that on the right hand side of the decision button 58b there is a return button 58c for resetting the content inputted into the option rights exercise chart 58a and returning to the client predictions input page 57 shown in FIG. 23.

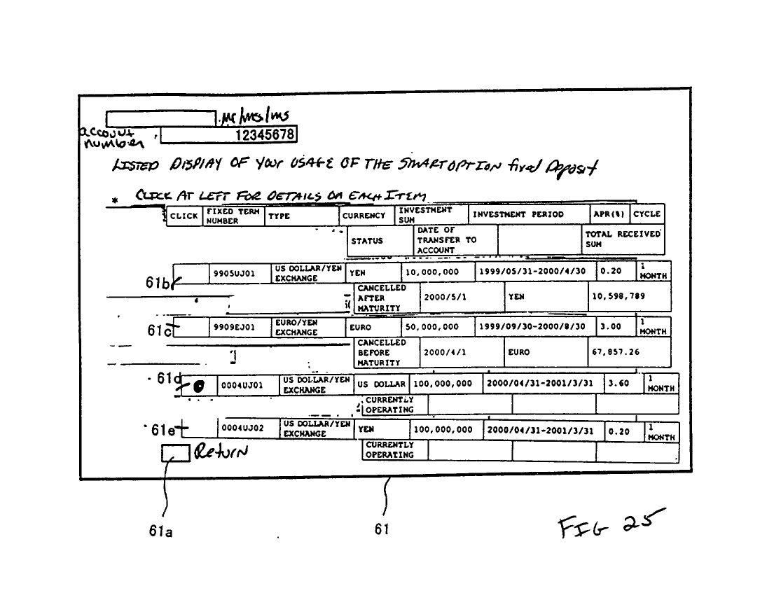

Next, explanation will be made of a procedure by which the client connects to the web page server 41 of the device for investing 40 and makes a request for premature contract cancellation for the financial derivative product 1 on the web page, making use of FIG. 25 through FIG. 27 which depict the web page. Note that in the case when such a request is made for premature contract cancellation, the procedure is the same up until the point of cancellation operation as the procedure already described regarding the case when the purchase request is made; therefore, detailed explanation of this similar portion is omitted here.

This is, from the web page 50 shown in FIG. 16 and the transaction request page 51 shown in FIG. 17, the client opens up the financial derivative product purchase request page 52, such as the one shown in FIG. 18, from which such operations as the purchase and cancellation of and confirmation of the management performance of the financial derivative product (smart option fixed deposit) 1 can be performed. In the case when a purchase has already been made and either the client wishes to know the management status of the capital used for the financial derivative product 1 which the client has already purchased or the client wishes to make a request for premature cancellation, the client clicks on an access button for clients currently engaged in utilization 52b.

When this happens, a page with a product management status list for clients currently engaged in utilization 61 opens up, such as the one shown in FIG. 25. This product management status list for clients currently engaged in utilization 61 displays data regarding the management status of each of the purchased products in terms of concrete values which are written in for each of the items including a fixed term deposit number; a product type; a type of currency in which the investment principal is provided; the investment sum (i.e., the investment principal); the investment period; annual interest (as a percentage); the investment cycle; the management status; the date of transfer to the account; a currency in which funds are received; and a total sum of the amount to be received. Further, the product management status list for clients currently engaged in utilization 61 displays not only the purchased products which are currently being managed (i.e., still are still during their effective contract periods) at that point in time, but also data of past purchased products which have already passed their maturation dates and have already ended their contract periods, and past purchased products for which have had their contracts cancelled before their maturation dates and no longer involve a contractual relationship.

Note that it is possible to produce a more detailed display of the management status of each of the purchased products. On the left end of each of the pieces of data in FIG. 25 which displays the management status of each of the products there are click portions 61b, 61c, 61d and 61e for opening up a management status details data chart page 62 for displaying more detailed data. Further, in the product management status list for clients currently engaged in utilization 61 there is provided a return button 61a for returning to the financial derivative product transaction request page 52 shown in FIG. 18. Therefore, after confirming the management status at the product management status list for clients currently engaged in utilization 61, it is possible to return from this page 61 to the financial derivative product transaction request page 52 and start a purchase request for a new financial derivative product 1.

Consider a situation in which the client clicks on the click portion 61d provided to the left side of the portion displaying the management status of a financial derivative product (with a fixed deposit number of 0004UJ01) which is currently being managed. The management status details data chart page 62 would then open up displaying more detailed data pertaining to the management status of the financial derivative product (having the fixed deposit number of 0004UJ01) currently being managed.

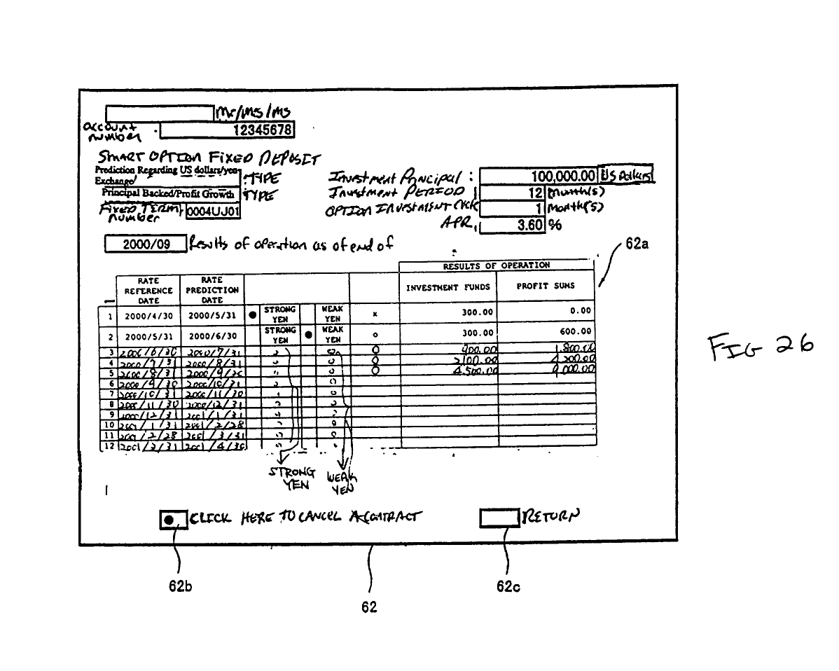

As shown in FIG. 26, the management status details data chart page 62 shows the product content of the given purchased product which corresponds to the fixed deposit number or other such information. Additionally, as shown in the lower portion of FIG. 26, the management status details data chart page 62 displays a management status chart 62a in which concrete values are written in for each item including the rate reference date; the rate prediction date (i.e., the option purchase date); the selected option (i.e., the client's prediction); results; the funds for investing; and profits. Further, in the results column a circle is displayed in the case when the client was able to exercise the option rights (i.e., when the prediction was accurate) and an X is displayed in the case when the option rights could not be exercised.

Further, it goes without saying that information is displayed in the management status chart 62a only for items which actually have results to be displayed. Therefore, the results column, the funds for investing column and the profits sum column are empty for rate prediction dates which have not arrived yet.

Additionally, in the lower portion of the management status chart 62a shown in FIG. 26, there is a confirmation button 62b for opening up a premature contract cancellation request page 63 for premature contract cancellation for the financial derivative product (having the fixed deposit number of 0004UJ01) currently being managed. Further, to the right hand side of this confirmation button 62b there is a return button 62c for returning to the product management status list for clients currently engaged in utilization 61 shown in FIG. 25. By returning to the product management status list for clients currently engaged in utilization 61, the client can open up from this page 61 the management status details data chart page 62 pertaining to the client's purchased products, and can view detailed data pertaining to the management status of other purchased products.

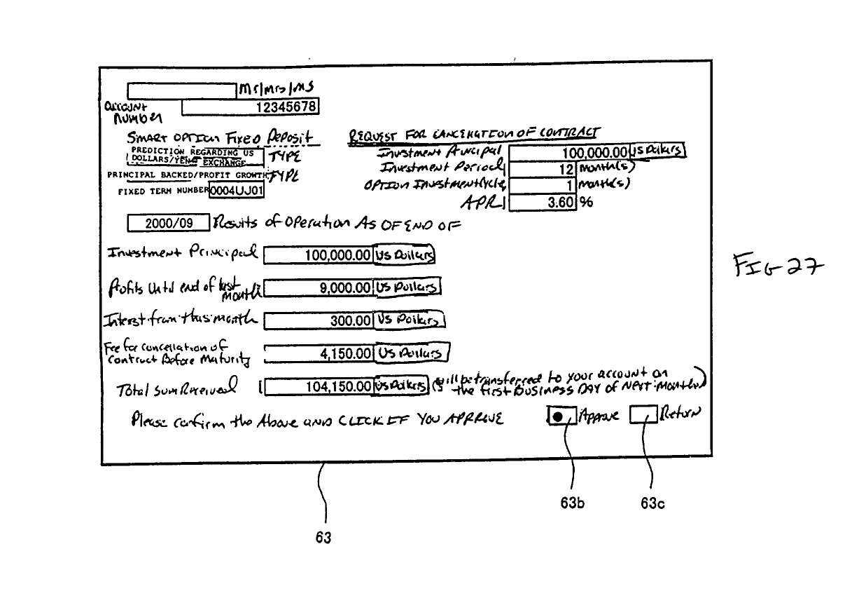

As shown in FIG. 27, the premature contract cancellation request page 63 shows the product content of a given purchased product corresponding to the fixed deposit number or other such data. Additionally, as shown in the lower portion of FIG. 27, the premature contract cancellation request page 63 displays the management performance up until that point in time. Specifically, various monetary sums are shown for the following items as applicable in the case of a premature cancellation of contract: the sum of the investment principal (US $100,000); profits through the previous month (US $9,000); interest for the current month (US $300); a premature contract cancellation fee (US $4,150); and a receivable total monetary sum (US $104,150).

Further, in the lower portion of the display portion there is a decision button 63b for acknowledging the premature contract cancellation based on the management performance shown in the upper portion, and for deciding to perform the premature contact cancellation. When the client clicks on this decision button 63b, this makes the request for the premature contact cancellation of the financial derivative product 1 complete. In other words, this cancels the sales contract between the financial institution and the client for the financial derivative product 1.

Further, in FIG. 27 on the right hand side of the decision button 63b, there is provided a return button 63c for returning to the product management status list for clients currently engaged in utilization 61 shown in FIG. 25. When the client returns to the product management status list for clients currently engaged in utilization 61, it is now possible to open up the management status details chart display page 62 and view detailed data of the management status of other purchased products. It is then also possible for the client to perform a premature contact cancellation for another purchased product from the premature contact cancellation request page 63.

Note that Embodiments described above each are examples of preferable embodiments of the present invention; however, the embodiments are not limited to these. Many types of embodiment variations are possible without departing from the scope of the present invention. One example, which was not particularly mentioned in connection with Embodiments described above, is that it is possible to have each of the web pages be updateable with the latest information by means of a refresh button, for example, provided in the browser.

As explained above, in the investing method, the device for investing, and the system for investing according to the present invention, a profit portion, which is obtained without diminishment of the interest set on the funds for investing or diminishment of the profits, for example, or the investment principal or a part of the investment principal (for example, 90%), is used for the costs of purchasing options; therefore, it is possible to reach the maturity date at least without loss of such funds as the investment principal.

In other words, from the perspective of the client, there may be a case in which a loss occurs due to a prediction proving to be inaccurate; however, even in this case almost all of the total sum of the investment principal and other such capital invested in the beginning is guaranteed to be paid back. At the same time, during a given period, option purchases are repeated using the interest, for example, as funds for investing for these purchases; therefore, the more the client's predictions prove to be accurate, the greater the profit the client can receive. Therefore, the client enjoys the stability of having the investment principal guaranteed, and yet there is also a possibility of obtaining a great profit.

What is claimed is:

1. An investing method, comprising the steps of:
appropriating a part of or all of interest set by a financial institution on an investment principal invested by a client for use as investment funds;
purchasing with said investment funds an option based on the client's prediction regarding a predetermined phenomenon on a predetermined date; and
repeating the purchase of an option step throughout a predetermined.

2. An investing method according to claim 1, wherein the purchasing of an option step is repeated on each of a plurality of predetermined dates during the predetermined period.

3. An investing method according to claim 1, wherein a part of or all of profits obtained by exercising a right on the option are added to the investment funds for a subsequent option purchase.

4. An investing method according to claim 1, wherein a part of the investment principal is added to the investment funds.

5. An investing method according to claim 1, wherein a part of or all of profits obtained by exercising a right on the option are incorporated into the investment principal, and a part of or all of interest generated on the investment principal according to interest set by the financial institution is allocated for a subsequent option purchase.

6. An investing method according to claim 1, wherein the investment principal is structured of instruments for generating interest or profit such as such as national currencies, funds for purchase of commodities, funds for purchase of bond certificates, funds for purchase of securities and funds for purchase of stocks.

7. An investing method according to claim 1, wherein a date for the option purchase occurs at an integer being equal to two times a cycle defined in units of days, weeks, months or years.

8. An investing method according to claim 7, wherein the option purchase period is set as an integer equal to twice that of the option purchase date.

9. An investing method according to claim 1, wherein the option is a financial option or a commodities option comprised of a listed option or an over-the-counter option.

10. An investing method according to claim 1, wherein the option type is either a plain vanilla option or an exotic option, and the exotic option is either a digital option CON (cash or nothing), a digital option AON (asset or nothing), an average option, a look-back option or a barrier option.

11. An investing method according to claim 1, wherein numeric values of financial products available for investment by the public, such as currency exchange rates, financial indices and financial futures indices are used as an index of the predetermined phenomenon.

12. An investing method according to claim 1, wherein the client's predictions regarding predetermined phenomena on predetermined dates are determined, at the time of start of use of the investing method, for each date during the predetermined period.

13. An investing method according to claim 1, wherein each time a right on an option purchase is exercised, the client's prediction regarding the predetermined phenomenon on the predetermined date is determined and the option purchase is performed.

14. An investing method according to claim 1, wherein an option based on the client's prediction regarding the predetermined phenomenon on the predetermined date is comprised of a call or put option for the predetermined date being compared against the time of start of use of the investing method.

15. An investing method according to claim 1, wherein an option based on the client's prediction regarding the predetermined phenomenon on the predetermined date is comprised of a call or put option for the predetermined date being compared against the time a point in time after the start of use of the investing method.

16. An investing method according to claim 1, wherein an option based on the client's prediction regarding the predetermined phenomenon on the predetermined date is comprised of a call or put option for the predetermined date being compared against a predetermined phenomenon on the previous occurrence of the predetermined date.

17. An investing method according to claim 1, wherein an option based on the client's prediction regarding the predetermined phenomenon on the predetermined date is comprised of a call or put option which is compared against a point in time after start of use of the investing method and which can be exercised at a freely chosen point in time after a predetermined duration of time has elapsed since the point time against which the call option or put option is compared.

18. An investing method according to claim 1, wherein designation by the client to stop the option purchases during the predetermined period causes a part of or all of the profits obtained by exercise of option rights up to that point to be incorporated into the investment principal or be able to be acquired by the client as profits.

19. An investing method according to claim 1, wherein in the case when profits obtained by exercise of option rights exceed a predetermined sum or exceed a predetermined ratio of the investment principal, option purchases after that point in time are stopped, and either a part of or all of the profits up to that point are incorporated into the investment principal or can be acquired by the client as profits.

20. An investing method according to claim 1, wherein financing secured by the investment principal can be used for purchasing financial derivative products which use the investing method.

21. An investing method, comprising the steps of:
distributing according to a number of instances of option purchases a part of or all of interest set by a financial institution on an investment principal being invested by a client;
using the distributed funds as investment funds for an option purchase based on the client's prediction regarding a predetermined phenomenon on a predetermined date; and
repeating the option purchase during a predetermined period.

22. An investing method according to claim 21, wherein the option purchase is performed repeatedly upon each occurrence of the predetermined date during the predetermined period.

23. An investing method according to claim 21, wherein a part of or all of profits obtained by exercising a right on the option are added to the investment funds for a subsequent option purchase.

24. An investing method according to claim 21, wherein a part of the investment principal is added to the investment funds.

25. An investing method according to claim 21, wherein a part of or all of profits obtained by exercising a right on the option are incorporated into the investment principal, and a part of or all of interest generated on the investment principal in this state according to interest set by the financial institution is allocated for a subsequent option purchase.

26. An investing method according to claim 21, wherein the investment principal is structured of instruments for generating interest or profit such as such as national currencies, funds for purchase of commodities, funds for purchase of bond certificates, funds for purchase of securities and funds for purchase of stocks.

27. An investing method according to claim 21, wherein a date for the option purchase occurs at an integer being equal to two times a cycle being defined in units of days, weeks, months or years.

28. An investing method according to claim 27, wherein the option purchase period is set as an integer equal to twice that of the option purchase date.

29. An investing method according to claim 21, wherein the option is a financial option or a commodities option comprised of a listed option or an over-the-counter option.

30. An investing method according to claim 21, wherein the option type is either a plain vanilla option or an exotic option, and the exotic option is either a digital option CON (cash or nothing), a digital option AON (asset or nothing), an average option, a look-back option or a barrier option.

31. An investing method according to claim 21, wherein numeric values of financial products available for investment by the public, such as currency exchange rates, financial indices and financial futures indices are used as an index of the predetermined phenomenon.

32. An investing method according to claim 21, wherein the client's predictions regarding predetermined phenomena on predetermined dates are determined, at the time of start of use of the investing method, for each date during the given predetermined period.

33. An investing method according to claim 21, wherein each time a right on an option purchase is exercised, the client's prediction regarding the predetermined phenomenon on the predetermined date is determined and the option purchase is performed.

34. An investing method according to claim 21, wherein an option based on the client's prediction regarding the predetermined phenomenon on the predetermined date is comprised of a call or put option for the predetermined date being compared against the time of start of use of the investing method.

35. An investing method according to claim 21, wherein an option based on the client's prediction regarding the predetermined phenomenon on the predetermined date is comprised of a call or put option for the predetermined date being compared against the time a point in time after the start of use of the investing method.

36. An investing method according to claim 21, wherein an option based on the client's prediction regarding the predetermined phenomenon on the predetermined date is comprised of a call or put option for the predetermined date being compared against a predetermined phenomenon on the previous occurrence of the predetermined date.

37. An investing method according to claim 21, wherein an option based on the client's prediction regarding the predetermined phenomenon on the predetermined date is comprised of a call or put option which is compared against a point in time after start of use of the investing method and which can be exercised at a freely chosen point in time after a predetermined duration of time has elapsed since the point time against which the call option or put option is compared.

38. An investing method according to claim 21, wherein designation by the client to stop the option purchases during the predetermined period causes a part of or all of the profits obtained by exercise of option rights up to that point to be incorporated into the investment principal or be able to be acquired by the client as profits.

39. An investing method according to claim 21, wherein in the case when profits obtained by exercise of option rights exceed a predetermined sum or exceed a predetermined ratio of the investment principal, option purchases after that point in time are stopped, and either a part of or all of the profits up to that point are incorporated into the investment principal or can be acquired by the client as profits.

40. An investing method according to claim 21, wherein financing secured by the investment principal can be used for purchasing financial derivative products which use the investing method.

41. An investing method, comprising the steps of:
repeating an option purchase during a given period for which an option purchase has been determined in advance; and
selecting by a client at least two of the following as investment funds for the option purchase:
(1) a part of or all of interest set by a financial institution on an investment principal being invested by the client;
(2) distributed funds consisting of funds that have been distributed from a part of or all of interest, according to a number of instances of option purchases;
(3) a combination of the investment principal and either (1) or (2) above;
(4) a combination of a part of or all of profits obtained by exercising a right on an option, and either (1) or (2) above;
(5) a combination of a part of or all of profits obtained by exercising a right on an option, and (3) above;
(6) an appropriate combination of (1)-(5) above.

42. An investing method according to claim 41, wherein the investment principal is structured of instruments for generating interest or profit such as such as national currencies, funds for purchase of commodities, funds for purchase of bond certificates, funds for purchase of securities and funds for purchase of stocks.

43. An investing method according to claim 41, wherein a date for the option purchase occurs at an integer being equal to two times a cycle being defined in units of days, weeks, months or years.

44. An investing method according to claim 43, wherein the option purchase period is set as an integer equal to twice that of the option purchase date.

45. An investing method according to claim 41, wherein the option is a financial option or a commodities option comprised of a listed option or an over-the-counter option.

46. An investing method according to claim 41, wherein the option type is either a plain vanilla option or an exotic option, and the exotic option is either a digital option CON (cash or nothing), a digital option AON (asset or nothing), an average option, a look-back option or a barrier option.

47. An investing method according to claim 41, wherein numeric values of financial products available for investment by the public, such as currency exchange rates, financial indices and financial futures indices are used as an index of the predetermined phenomenon.

48. An investing method according to claim 41, wherein the client's predictions regarding predetermined phenomena on predetermined dates are determined, at the time of start of use of the investing method, for each date during the given predetermined period.

49. An investing method according to claim 41, wherein each time a right on an option purchase is exercised, the client's prediction regarding the predetermined phenomenon on the predetermined date is determined and the option purchase is performed.

50. An investing method according to claim 41, wherein an option based on the client's prediction regarding the predetermined phenomenon on the predetermined date is comprised of a call or put option for the predetermined date being compared against the time of start of use of the investing method.

51. An investing method according to claim 41, wherein an option based on the client's prediction regarding the predetermined phenomenon on the predetermined date is comprised of a call or put option for the predetermined date being compared against the time a point in time after the start of use of the investing method.

52. An investing method according to claim 41, wherein an option based on the client's prediction regarding the predetermined phenomenon on the predetermined date is comprised of a call or put option for the predetermined date being compared against a predetermined phenomenon on the previous occurrence of the predetermined date.

53. An investing method according to claim 41, wherein an option based on the client's prediction regarding the predetermined phenomenon on the predetermined date is comprised of a call or put option which is compared against a point in time after start of use of the investing method and which can be exercised at a freely chosen point in time after a predetermined duration of time has elapsed since the point time against which the call option or put option is compared.

54. An investing method according to claim 41, wherein designation by the client to stop the option purchases during the predetermined period causes a part of or all of the profits obtained by exercise of option rights up to that point to be incorporated into the investment principal or be able to be acquired by the client as profits.

55. An investing method according to claim 41, wherein in the case when profits obtained by exercise of option rights exceed a predetermined sum or exceed a predetermined ratio of the investment principal, option purchases after that point in time are stopped, and either a part of or all of the profits up to that point are incorporated into the investment principal or can be acquired by the client as profits.

56. An investing method according to claim 41, wherein financing secured by the investment principal can be used for purchasing financial derivative products which use the investing method.

57. A device for investing capable of being connected to/from a client terminal device via a high-speed communications network, and additionally capable of inputting and outputting information relevant to transactions with the connected client, wherein it is possible to perform at least either a purchase request for or a cancellation of a contract for a financial derivative product which uses an investing method wherein a part of or all of interest set by a financial institution on an investment principal invested by a client is appropriated for use as investment funds for purchasing an option based on the client's prediction regarding a predetermined phenomenon on a predetermined date, and wherein this option purchase is repeated throughout a predetermined period.

58. A device for investing according to claim 57, wherein the client can use the client terminal device to perform at least either an online purchase of or an online cancellation of a contract for the financial derivative product which uses the investing method.

59. A device for investing capable of being connected to/from a client terminal device via a high-speed communications network, and additionally capable of inputting and outputting information relevant to transactions with the connected client, wherein it is possible to perform at least either a purchase request for or a cancellation of a contract for a financial derivative product which uses an investing method wherein a part of or all of interest set by a financial institution on an investment principal invested by a client is distributed according to a number of instances of option purchases, and these distributed funds are used as investment funds for purchasing an option based on the client's prediction regarding a predetermined phenomenon on a predetermined date, and wherein this option purchase is repeated throughout a given period having been determined in advance.

60. A device for investing according to claim 59, wherein the client can use the client terminal device to perform at least either an online purchase of or an online cancellation of a contract for the financial derivative product which uses the investing method.

61. A device for investing capable of being connected to/from a client terminal device via a high-speed communications network, and additionally capable of inputting and outputting information relevant to transactions with the connected client, wherein it is possible to perform at least either a purchase request for or a cancellation of a contract for a financial derivative product which uses an investing method wherein an option purchase is repeated throughout a given period having been determined in advance and wherein it is possible for a client to select at least two of the following as investment funds for the option purchase:
(1) a part of or all of interest set by a financial institution on an investment principal being invested by the client;
(2) distributed funds consisting of funds that have been distributed from a part of or all of interest, according to a number of instances of option purchases;
(3) a combination of the investment principal and either (1) or (2) above;
(4) a combination of a part of or all of profits obtained by exercising a right on an option, and either (1) or (2) above;
(5) a combination of a part of or all of profits obtained by exercising a right on an option, and (3) above;
(6) an appropriate combination of (1)-(5) above.

62. A device for investing according to claim 61, wherein the client can use the client terminal device to perform at least either an online purchase of or an online cancellation of a contract for the financial derivative product which uses the investing method.

63. A device for investing comprising: a client information database in which client information including an account number is stored; a product database in which the content of each type of product is stored; an investment information database in which investment information including an applied rate of return is stored; a sales management database in which each type of data for each product purchased by each client is stored; and a management server connected to the databases and capable of inputting and outputting personal information and transaction information relevant to the client, wherein in the case when personal information relevant to the client is inputted to the management database the client information database is referenced based on the inputted data and the client is certified; the product database and the investment information database are referenced regarding the certified client and products which the financial institution can provide to that client at the time when the information is inputted are disclosed; and by inputting the certified client's transaction conditions a purchase request is performed in accordance with these inputted conditions for a financial derivative product which uses an investing method wherein a part of or all of interest set by a financial institution on an investment principal invested by a client is appropriated for use as investment funds for purchasing an option based on the client's prediction regarding a predetermined phenomenon on a predetermined date, and wherein this option purchase is repeated throughout a given period having been determined in advance; and the content of this transaction is inputted to the sales management database and managed.

64. A device for investing according to claim 63, wherein the management server, after certification of the client, references the sales management database and discloses to the client the financial derivative products already purchased by the client; and after the client confirms the content of the financial derivative product transaction, a predetermined input is made to the management server by which it becomes possible to perform a cancellation of a contract for a financial derivative product which has already been purchased, and additionally, information stating that the cancellation of contract was performed is sent to the client information database and the sales management database and this information is stored in both databases.

65. A device for investing according to claim 63, wherein the management server is constructed so as to be capable of being connected to/from a client terminal device via a high-speed communications network, and the client can perform at least either a purchase request for or a cancellation of a contract for the financial derivative product by connecting to the management server from the client terminal device.

66. A device for investing according to claim 63, wherein the management server is connected to an operating funds information database which is connected to at least one of either a listed options market or an over-the-counter options market.

67. A device for investing comprising: a client information database in which client information including an account number is stored; a product database in which the content of each type of product is stored; an investment information database in which investment information including an applied rate of return is stored; a sales management database in which each type of data for each product purchased by each client is stored; and a management server connected to the databases and capable of inputting and outputting personal information and transaction information relevant to the client, wherein in the case when personal information relevant to the client is inputted to the management database the client information database is referenced based on the inputted data and the client is certified; the product database and the investment information database are referenced regarding the certified client and products which the financial institution can provide to that client at the time when the information is inputted are disclosed; and by inputting the certified client's transaction conditions a purchase request is performed in accordance with these inputted conditions for a financial derivative product which uses an investing method wherein a part of or all of interest set by a financial institution on an investment principal being invested by a client is distributed according to a number of instances of option purchases, and these distributed funds are used as investment funds for purchasing an option based on the client's prediction regarding a predetermined phenomenon on a predetermined date, and wherein this option purchase is repeated throughout a given period having been determined in advance; and the content of this transaction is inputted to the sales management database and managed.

68. A device for investing according to claim 67, wherein the management server, after certification of the client, references the sales management database and discloses to the client the financial derivative products already purchased by the client; and after the client confirms the content of the financial derivative product transaction, a predetermined input is made to the management server by which it becomes possible to perform a cancellation of a contract for a financial derivative product which has already been purchased, and additionally, information stating that the cancellation of contract was performed is sent to the client information database and the sales management database and this information is stored in both databases.

69. A device for investing according to claim 67, wherein the management server is constructed so as to be capable of being connected to/from a client terminal device via a high-speed communications network, and the client can perform at least either a purchase request for or a cancellation of a contract for the financial derivative product by connecting to the management server from the client terminal device.

70. A device for investing according to claim 67, wherein the management server is connected to an operating funds information database which is connected to at least one of either a listed options market or an over-the-counter options market.

71. A device for investing comprising: a client information database in which client information including an account number is stored; a product database in which the content of each type of product is stored; an investment information database in which investment information including an applied rate of return is stored; a sales management database in which each type of data for each product purchased by each client is stored; and a management server connected to the databases and capable of inputting and outputting personal information and transaction information relevant to the client, wherein in the case when personal information relevant to the client is inputted to the management database the client information database is referenced based on the inputted data and the client is certified; the product database and the investment information database are referenced regarding the certified client and products which the financial institution can provide to that client at the time when the information is inputted are disclosed; by inputting this certified client's transaction conditions an option purchase is repeated according to the inputted conditions during a given period for which an option purchase has been determined in advance; and additionally, a request is performed for purchase of a financial derivative product which uses an investing method wherein it is possible for the client to select at least two of the following as investment funds for the option purchase:
(1) a part of or all of interest set by a financial institution on an investment principal being invested by the client;
(2) distributed funds consisting of funds that have been distributed from a part of or all of interest, according to a number of instances of option purchases;
(3) a combination of the investment principal and either (1) or (2) above;
(4) a combination of a part of or all of profits obtained by exercising a right on an option, and either (1) or (2) above;
(5) a combination of a part of or all of profits obtained by exercising a right on an option, and (3) above;
(6) an appropriate combination of (1)-(5) above; and
the content of this transaction is inputted to the sales management database and managed.

72. A device for investing according to claim 71, wherein the management server, after certification of the client, references the sales management database and discloses to the client the financial derivative products already purchased by the client; and after the client confirms the content of the financial derivative product transaction, a predetermined input is made to the management server by which it becomes possible to perform a cancellation of a contract for a financial derivative product which has already been purchased, and additionally, information stating that the cancellation of contract was performed is sent to the client information database and the sales management database and this information is stored in both databases.

73. A device for investing according to claim 71, wherein the management server is constructed so as to be capable of being connected to/from a client terminal device via a high-speed communications network, and the client can perform at least either a purchase request for or a cancellation of a contract for the financial derivative product by connecting to the management server from the client terminal device.

74. A device for investing according to claim 71, wherein the management server is connected to an operating funds information database which is connected to at least one of either a listed options market or an over-the-counter options market.

75. An investing system for implementing an investing method wherein a part of or all of interest set by a financial institution on an investment principal invested by a client is appropriated for use as investment funds for purchasing an option based on the client's prediction regarding a predetermined phenomenon on a predetermined date, and this option purchase is repeated throughout a given period having been determined in advance, wherein the investing system comprises a device for investing which is capable of being connected to/from a client terminal device via a high-speed communications network, and is additionally capable of inputting and outputting information relevant to transactions with the connected client, whereby the client can use the client terminal device to purchase a financial derivative product which uses the investing method.

76. An investing system according to claim 75, wherein cancellation of a contract for a financial derivative product purchased by the client can be performed using the client terminal device.

77. An investing system according to claim 75, wherein the client can use the device for investing to open an account with a financial institution which manages the device for investing, and also, can deposit into the account profits obtained by purchase of the financial derivative product.

78. An investing system for implementing an investing method wherein a part of or all of interest set by a financial institution on an investment principal invested by a client is distributed according to a number of instances of option purchases, and these distributed funds are used as investment funds for purchasing an option based on the client's prediction regarding a predetermined phenomenon on a predetermined date, and this option purchase is repeated throughout a given period having been determined in advance, wherein the investing system comprises a device for investing which is capable of being connected to/from a client terminal device via a high-speed communications network, and is additionally capable of inputting and outputting information relevant to transactions with the connected client, whereby the client can use the client terminal device to purchase a financial derivative product which uses the investing method.

79. An investing system according to claim 78, wherein cancellation of a contract for a financial derivative product purchased by the client can be performed using the client terminal device.

80. An investing system according to claim 78, wherein the client can use the device for investing to open an account with a financial institution which manages the device for investing, and also, can deposit into the account profits obtained by purchase of the financial derivative product.

81. An investing system for implementing an investing method wherein an option purchase is repeated during a given period for which an option purchase has been determined in advance, and additionally, it is possible for the client to select at least two of the following as investment funds for the option purchase:
(1) a part of or all of interest set by a financial institution on an investment principal being invested by the client;
(2) distributed funds consisting of funds that have been distributed from a part of or all of interest, according to a number of instances of option purchases;
(3) a combination of the investment principal and either (1) or (2) above;
(4) a combination of a part of or all of profits obtained by exercising a right on an option, and either (1) or (2) above;
(5) a combination of a part of or all of profits obtained by exercising a right on an option, and (3) above;
(6) an appropriate combination of (1)-(5) above,
wherein the investing system comprises a device for investing which is capable of being connected to/from a client terminal device via a high-speed communications network, and is additionally capable of inputting and outputting information relevant to transactions with the connected client, whereby the client can use the client terminal device to purchase a financial derivative product which uses the investing method.

82. An investing system according to claim 81, wherein cancellation of a contract for a financial derivative product purchased by the client can be performed using the client terminal device.

83. An investing system according to claim 81, wherein the client can use the device for investing to open an account with a financial institution which manages the device for investing, and also, can deposit into the account profits obtained by purchase of the financial derivative product.

84. An investing system for implementing an investing method wherein a part of or all of interest set by a financial institution on an investment principal invested by a client is appropriated for use as investment funds for purchasing an option based on the client's prediction regarding a predetermined phenomenon on a predetermined date, and this option purchase is repeated throughout a given period having been determined in advance, wherein the client's personal information can be inputted and the client can be certified by referencing the inputted information, and after the certification, a purchase request for a financial derivative product using the investing method can be performed by inputting the client's desired transaction conditions.

85. An investing system according to claim 84, wherein in the case when the client is a new client an account with the financial institution managing the investing system can be opened by inputting predetermined client information; after opening the account the certification of the client can performed; and after the certification, the purchase request can be performed by inputting the client's desired transaction conditions.

86. An investing system according to claim 84, wherein in the case when the client is a client which has already purchased the financial derivative product, a cancellation of contract for the financial derivative product already purchased can be performed after the confirmation by performing a predetermined input.

87. An investing system for implementing an investing method wherein a part of or all of interest set by a financial institution on an investment principal being invested by a client is distributed according to a number of instances of option purchases, and these distributed funds are used as investment funds for purchasing an option based on the client's prediction regarding a predetermined phenomenon on a predetermined date, and this option purchase is repeated throughout a given period having been determined in advance, wherein the client's personal information can be inputted and the client can be certified by referencing the inputted information, and after the certification, a purchase request for a financial derivative product using the investing method can be performed by inputting the client's desired transaction conditions.

88. An investing system according to claim 87, wherein in the case when the client is a new client an account with the financial institution managing the investing system can be opened by inputting predetermined client information; after opening the account the certification of the client can performed; and after the certification, the purchase request can be performed by inputting the client's desired transaction conditions.

89. An investing system according to claim 87, wherein in the case when the client is a client which has already purchased the financial derivative product, a cancellation of contract for the financial derivative product already purchased can be performed after the confirmation by performing a predetermined input.

90. An investing system for implementing an investing method wherein an option purchase is repeated during a given period for which an option purchase has been determined in advance, and additionally, it is possible for the client to select at least two of the following as investment funds for the option purchase:
(1) a part of or all of interest set by a financial institution on an investment principal being invested by the client;
(2) distributed funds consisting of funds that have been distributed from a part of or all of interest, according to a number of instances of option purchases;
(3) a combination of the investment principal and either (1) or (2) above;
(4) a combination of a part of or all of profits obtained by exercising a right on an option, and either (1) or (2) above;
(5) a combination of a part of or all of profits obtained by exercising a right on an option, and (3) above;
(6) an appropriate combination of (1)-(5) above, wherein the client's personal information can be inputted and the client can be certified by referencing the inputted information, and after the certification, a purchase request for a financial derivative product using the investing method can be performed by inputting the client's desired transaction conditions.

91. An investing system according to claim 90, wherein in the case when the client is a new client an account with the financial institution managing the investing system can be opened by inputting predetermined client information; after opening the account the certification of the client can performed; and after the certification, the purchase request can be performed by inputting the client's desired transaction conditions.

92. An investing system according to claim 90, wherein in the case when the client is a client which has already purchased the financial derivative product, a cancellation of contract for the financial derivative product already purchased can be performed after the confirmation by performing a predetermined input.
